(19) United States
(12) Patent Application Publication
(10) Pub. No.: US 2026/0350471 A1
(43) Pub. Date: Nov. 5, 2026

(54) METHOD AND ELECTRONIC DEVICE FOR USING ARTIFICIAL INTELLIGENCE MODEL TO PERFORM PLURALITY OF TASKS BASED ON TASK TYPES

(71) Applicant: SAMSUNG ELECTRONICS CO., LTD., Suwon-si (KR)

(72) Inventors: Dongwon PARK, Suwon-si (KR); Eojindl YI, Suwon-si (KR); Yooshin CHO, Suwon-si (KR); Jaewook SHIN, Suwon-si (KR)

(73) Assignee: SAMSUNG ELECTRONICS CO., LTD., Suwon-si (KR)

(21) Appl. No.: 19/663,884

(22) Filed: Apr. 30, 2026

Related U.S. Application Data
(63) Continuation of application No. PCT/KR2026/096435, filed on Apr. 29, 2026.

(30) Foreign Application Priority Data
Apr. 30, 2025 (KR) 10-2025-0057738
Aug. 12, 2025 (KR) 10-2025-0111492

(51) Int. Cl. G06N 20/00

(52) U.S. Cl. CPC G06N 20/00

(57) ABSTRACT

A method includes obtaining an input prompt and reference data determining at least one task type corresponding to the input prompt, adding, to the input prompt, a token indicating the determined at least one task type, based on the at least one task type, embedding position information in the reference data, inputting, to an artificial intelligence (AI) model, the input prompt including the token and the reference data including the position information, and providing an output corresponding to the input prompt, based on an output of the AI model.

### CROSS-REFERENCE TO RELATED APPLICATIONS

This application is a continuation of International Application No. PCT/KR2026/096435, filed on Apr. 29, 2026, which is based on and claims priority to Korean Provisional Application No. 10-2025-0057738, filed on Apr. 30, 2025, in the Korean Intellectual Property Office, and Korean Patent Application No. 10-2025-0111492, filed on Aug. 12, 2025, in the Korean Ministry of Intellectual Property, the disclosures of which are incorporated by reference herein in their entireties.

### BACKGROUND

### 1. Field

The disclosure relates to a method and an electronic device for using an artificial intelligence (AI) model, and more particularly, to a method and an electronic device for using an AI model to perform a plurality of tasks, based on task types.

### 2. Description of Related Art

A neural network model, or an artificial intelligence (AI) model, refers to a mathematical model generated by emulating the neuronal structure of the human brain, and can perform a prediction task or a classification task based on a received data input. The neural network model may be trained on data and may perform predictions via a plurality of layers, such as, an input layer, a hidden layer, and an output layer. Each of the layers may have a plurality of nodes or neurons.

A generative AI model may be a neural network model or an AI model which is designed to generate new data from provided data. The generative AI model may generate creative and new samples, based on a trained distribution. The generative AI model may be trained on existing data, and may generate various types of outputs such as text, images, or music, based on the trained distribution.

### SUMMARY

According to an aspect of the disclosure, a method includes: obtaining an input prompt and reference data; determining at least one task type corresponding to the input prompt; adding, to the input prompt, a token indicating the determined at least one task type; based on the determined at least one task type, embedding position information in the reference data; inputting, to an artificial intelligence (AI) model, the input prompt including the token and the reference data including the position information; and providing an output corresponding to the input prompt, based on an output of the AI model.

The determining of the at least one task type corresponding to the input prompt may include: inputting the input prompt to a language model trained to classify a target task of a given prompt to at least one type; and determining the at least one task type, based on an output of the language model.

The determining of the at least one task type corresponding to the input prompt may include: obtaining task information indicating a target task of the input prompt; and determining at least one type of the target task, based on the task information.

The embedding of the position information in the reference data may include: obtaining at least one feature representing the reference data by encoding the reference data; generating at least one position embedding representing a position of the at least one feature, by using a position offset corresponding to the determined at least one task type; and combining the at least one position embedding with the at least one feature.

The determining of the at least one task type corresponding to the input prompt may include determining a first task type and a second task type which correspond to the input prompt. The adding of, to the input prompt, the token indicating the determined at least one task type may include adding, to the input prompt, a first token indicating the first task type and a second token indicating the second task type.

The determining of the at least one task type corresponding to the input prompt may include determining a first task type and a second task type which correspond to the input prompt. The embedding of the position information in the reference data may include: obtaining at least one feature representing the reference data by encoding the reference data; generating at least one position embedding indicating a position of the at least one feature, by using a first position offset corresponding to the first task type and a second position offset corresponding to the second task type; and combining the at least one position embedding with the at least one feature.

The method may include obtaining an additional input prompt associated with the output of the AI model; determining at least one additional task type corresponding to the additional input prompt; adding, to the additional input prompt, an additional token indicating the determined at least one additional task type; embedding additional position information in the output of the AI model, based on the determined at least one additional task type; inputting, to the AI model, the additional input prompt including the additional token and the output of the AI model including the additional position information; obtaining an additional output from the AI model; and providing an output corresponding to the additional input prompt, based on the additional output from the AI model.

The obtaining of the input prompt and the reference data may include obtaining one or more object areas in the reference data which are related to a target task of the input prompt.

The determining of the at least one task type corresponding to the input prompt may include: identifying at least one of an object included in the reference data or the input prompt; and determining the at least one task type corresponding to the input prompt, based on the identified at least one object.

The embedding of the position information in the reference data may include: identifying a modality of the reference data; and embedding the position information in the reference data, based on the identified modality of the reference data.

According to an aspect of the disclosure, a computer program is stored in a non-transitory computer-readable recording medium, the computer program including instructions to cause a processor configured to perform the methods described herein.

According to an aspect of the disclosure, an electronic device includes: one or more processors including processing circuitry; and memory storing at least one instruction. The at least one instruction, when executed by the one or more processors individually or collectively, causes the electronic device to: obtain an input prompt and reference data determine at least one task type corresponding to the input prompt, add, to the input prompt, a token indicating the determined at least one task type, based on the determined at least one task type, embed position information in the reference data, input, to an artificial intelligence (AI) model, the input prompt including the token and the reference data including the position information, and provide an output corresponding to the input prompt, based on an output of the AI model.

The at least one instruction, when executed by the one or more processors individually or collectively, may cause the electronic device to: input the input prompt to a language model trained to classify a target task of a given prompt to at least one type, and determine the at least one task type, based on an output of the language model.

The at least one instruction, when executed by the one or more processors individually or collectively, may cause the electronic device to: obtain task information indicating a target task of the input prompt, and determine at least one type of the target task, based on the task information.

The at least one instruction, when executed by the one or more processors individually or collectively, may cause the electronic device to: obtain at least one feature representing the reference data by encoding the reference data, generate at least one position embedding representing a position of the at least one feature, by using a position offset corresponding to the determined at least one task type, and combine the at least one position embedding with the at least one feature.

The at least one instruction, when executed by the one or more processors individually or collectively, may cause the electronic device to: determine a first task type and a second task type which correspond to the input prompt, and add, to the input prompt, a first token indicating the first task type and a second token indicating the second task type.

The at least one instruction, when executed by the one or more processors individually or collectively, may cause the electronic device to: determine a first task type and a second task type which correspond to the input prompt, obtain at least one feature representing the reference data by encoding the reference data, generate at least one position embedding indicating a position of the at least one feature, by using a first position offset corresponding to the first task type and a second position offset corresponding to the second task type, and combine the at least one position embedding with the at least one feature.

The at least one instruction, when executed by the one or more processors individually or collectively, may cause the electronic device to obtain one or more object areas in the reference data which are related to a target task of the input prompt.

The at least one instruction, when executed by the one or more processors individually or collectively, may cause the electronic device to: identify at least one of an object included in the reference data or the input prompt, and determine the at least one task type corresponding to the input prompt, based on the identified at least one object.

The at least one instruction, when executed by the one or more processors individually or collectively, may cause the electronic device to: identify a modality of the reference data, and embed the position information in the reference data, based on the identified modality of the reference data.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a plurality of tasks being performed by using an artificial intelligence (AI) model based on a user input, according to one or more embodiments of the disclosure;

FIG. 2 is a block diagram of an electronic device according to one or more embodiments of the disclosure;

FIG. 3 illustrates a flowchart of a method according to one or more embodiments of the disclosure;

FIG. 4 illustrates an input prompt and reference data being input to an AI model, according to one or more embodiments of the disclosure;

FIGS. 5A, 5B, and 5C illustrate task type classifiers according to one or more embodiments of the disclosure;

FIGS. 6A and 6B illustrate task-specific position embeddings, according to one or more embodiments of the disclosure;

FIG. 7 illustrates a process of generating an output image based on an input prompt and reference data, according to one or more embodiments of the disclosure;

FIG. 8 illustrates a flowchart of a method of training an AI model, according to one or more embodiments of the disclosure;

FIG. 9 illustrates an AI model being trained, according to one or more embodiments of the disclosure;

FIG. 10 illustrates a graphic user interface (GUI) provided to a user, according to one or more embodiments of the disclosure;

FIG. 11A illustrates a GUI for displaying an input prompt and reference data input by a user, according to one or more embodiments of the disclosure;

FIG. 11B displays a GUI that displays an image generated based on the input prompt and reference data of FIG. 11A, according to one or more embodiments of the disclosure;

FIG. 12A illustrates a GUI that displays the generated image of FIG. 11B as reference data, according to one or more embodiments of the disclosure;

FIG. 12B illustrates a GUI that displays an area on a reference image which is selected by a user in FIG. 12A, according to one or more embodiments of the disclosure;

FIG. 12C illustrates a GUI that displays an image generated based on an input prompt and reference data of FIG. 12B, according to one or more embodiments of the disclosure;

FIG. 13A illustrates a GUI that displays the generated image of FIG. 11B as reference data, according to one or more embodiments of the disclosure;

FIG. 13B illustrates a GUI that displays an image generated based on an input prompt and reference data of FIG. 13A, according to one or more embodiments of the disclosure;

FIG. 14 illustrates a GUI that displays a task select function, according to one or more embodiments of the disclosure;

FIG. 15 illustrates a GUI that displays a chatbot application, according to one or more embodiments of the disclosure;

FIG. 16 illustrates a GUI that displays an element for selecting a type of reference data, according to one or more embodiments of the disclosure; and

FIG. 17 illustrates a block diagram of a system according to one or more embodiments of the disclosure.

### DETAILED DESCRIPTION

Although the terms used in embodiments of the disclosure are selected from among common terms that are currently widely used in consideration of their functions in the disclosure, the terms may vary according to the intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

The terms used in the disclosure are just for the purpose of describing particular embodiments of the disclosure and are not intended to limit the scope of other embodiment of disclosure. As used herein, the singular forms “a,” “an,” and “the” may include the plural forms as well, unless the context clearly indicates otherwise. All the terms used in the present specification, including technical and scientific terms, may have the same meanings as those generally understood by one of skill in the art of the disclosure. The terms of the disclosure which are defined in commonly used dictionaries may be interpreted as having the same meanings as the contextual meanings of the related art and will not be interpreted in an idealized or overly formal sense unless expressly so defined herein. In some cases, even the terms defined in the disclosure may not be interpreted to exclude the embodiments of the disclosure.

Hereinafter, a hardware-based method will be described as an example in various embodiments of the disclosure. However, as various embodiments of the disclosure include technology using both hardware and software, various embodiments of the disclosure do not exclude software-based methods.

Also, in the disclosure, when a part “includes” or “comprises” an element, unless there is a particular description contrary thereto, the part can further include other elements, not excluding the other elements. Also, the terms such as “ . . . unit,” “module,” or the like used in the disclosure indicate a unit, which processes at least one function or operation, and the unit may be implemented by hardware or software, or by a combination of hardware and software.

The expression “configured to (or set to)” used in the disclosure may be replaced with, for example, “suitable for,” “having the capacity to,” “designed to,” “adapted to,” “made to,” or “capable of” according to cases. The expression “configured to (or set to)” may not necessarily mean “specifically designed to” at a hardware level. Instead, in some cases, the expression “system configured to . . . ” may mean that the system is “capable of . . . ” along with other devices or parts. For example, “a processor configured to (or set to) perform A, B, and C” may refer to a dedicated processor (e.g., an embedded processor) for performing a corresponding operation, or a general-purpose processor (e.g., a central processing unit (CPU) or an application processor (AP)) capable of performing a corresponding operation by executing one or more software programs stored in a memory.

Also, in the disclosure, it should be understood that when elements are “connected” or “coupled” to each other, the elements may be directly connected or coupled to each other, but may alternatively be connected or coupled to each other with an element therebetween, unless specified otherwise.

In the disclosure, the expressions such as ‘greater than’ or ‘less than’ may be used to determine whether particular conditions are satisfied or fulfilled, however, these are merely examples, and do not exclude descriptions using ‘greater than or equal to’ or ‘less than or equal to’. A condition described as ‘greater than or equal to’ may be replaced with ‘greater than,’ a condition described as ‘less than or equal to’ may be replaced with ‘less than,’ and a condition described as ‘greater than or equal to and less than’ may be replaced with ‘greater than and less than or equal to’.

It will be understood that the blocks in the flowcharts and combinations of the flowcharts in the disclosure may be implemented by one or more computer programs including computer-executable instructions. The one or more computer programs may be all stored in a single memory, or may be stored in a plurality of different memories in a distributed fashion.

All functions or operations described in the present specification may be processed by one processor or a combination of processors. One or more processors according to the disclosure may include at least one of a central processing unit (CPU), a graphics processing unit (GPU), an accelerated processing unit (APU), a many integrated core (MIC), a digital signal processor (DSP), or a neural processing unit (NPU). One or more processors may be implemented in the form of an integrated system on chip (SoC) including one or more electronic components. One or more processors may each be implemented as separate hardware (H/W).

When the method according to one or more embodiments of the disclosure includes a plurality of operations, the operations may be performed by one processor or a plurality of processors. For example, when a first operation, a second operation, and a third operation are performed by the method according to one or more embodiments of the disclosure, the first operation, the second operation, and the third operation may all be performed by a first processor. Alternatively, the first operation and the second operation may be performed by a first processor (e.g., a generic-purpose processor) and the third operation may be performed by a second processor (e.g., a dedicated artificial intelligence (AI) processor). However, embodiments of the disclosure are not limited thereto.

One or more processors according to the disclosure may be implemented as a single core processor, or may be implemented as a multicore processor.

When the method according to one or more embodiments of the disclosure includes a plurality of operations, the plurality of operations may be performed by one core, or may be performed by a plurality of cores included in one or more processors.

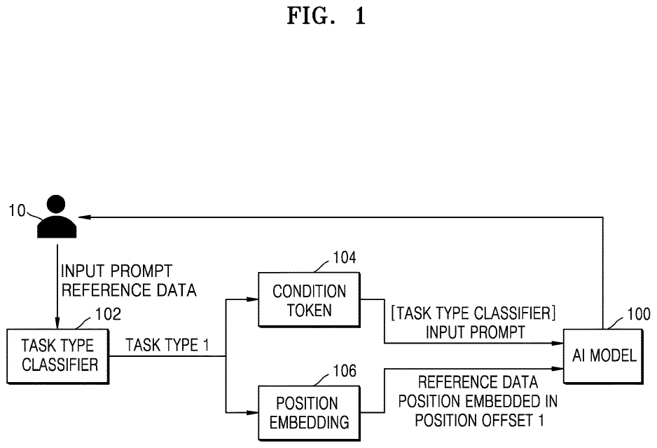

FIG. 1 illustrates a plurality of tasks being performed by using an AI model 100, based on a user input, according to one or more embodiments of the disclosure.

Referring to FIG. 1, a user 10 may provide an input prompt and reference data to the AI model 100. Based on at least one of the input prompt or the reference data provided by the user 10, a task type classifier 102 may classify a type of a task, or a plurality of tasks, that the user 10 attempts to perform via the AI model 100. Based on the task type classified by the task type classifier 102, the input prompt and the reference data may be pre-processed. For example, an output generation path of the AI model 100, which is appropriate for the task type, may be automatically selected. Accordingly, the AI model 100 may process a plurality of tasks.

According to one or more embodiments of the disclosure, the AI model 100 may be a generative model trained to generate new data, based on a given input prompt and given reference data. For example, the AI model 100 may be trained on training data with respect to a pattern and structure, and may generate at least one form of data among various forms such as text, an image, or audio, based on a given condition such as an input prompt or reference data. According to one or more embodiments of the disclosure, the AI model 100 may be implemented based on any combination of various models including a generative adversarial network (GAN), a variational autoencoder (VAE), a diffusion model, an autoregressive model, a flow-based model, a transformer-based model, or an autoregression model.

An input prompt obtained from the user 10 may be embodied as a text input including a request, a command, or an instruction with respect to the AI model 100. For example, the input prompt may be a text input for indicating, instructing, informing, or teaching the AI model 100 for a specific task or a goal such as “Convert this person's photo into an animated style” or “Change the background of the product”.

The reference data obtained from the user 10 may be a reference, a reference point, or a target object of a task or an operation to be performed by the AI model 100. For example, the input prompt from the user 10 may include a request for performing a specific task on the reference data, or a request for generating an output based at least partially on the reference data.

The task type classifier 102 may classify a type of a task requested by the user 10, based on at least one of the input prompt or the reference data. For example, based on at least one of the input prompt or the reference data, the task type classifier 102 may determine the type of the task requested by the user 10, as any one among at least one defined task type or task families. Task types or task families may be one or more groups that are pre-classified from at least one task that the AI model 100 may perform. The task type classifier 102 may classify the task requested by the user 10 into one or more task types.

According to one or more embodiments of the disclosure, at least one task type may be pre-defined, based on an input modality that the AI model 100 has been trained to process. For example, based on the AI model 100 being trained to process an image input, the at least one task type may be pre-defined in consideration of features of a plurality of operations that may be performed on the image input or requirements for an output of the AI model 100.

According to one or more embodiments of the disclosure, based on the AI model 100 being trained to process an image input, the at least one task type may be pre-defined in consideration of various requirements as to whether a specific object of reference data has to be spatially aligned in an output of the AI model 100 or as to whether deformation of the specific object of the reference data is required to perform a task.

In one or more embodiments, tasks (example: deletion of object, addition of object, conversion of image style, conversion of object color, etc.) for which the specific object of the reference data has to be spatially aligned in the output of the AI model 100 may be classified as a first type. For example, a task type corresponding to an input prompt such as “Convert this into XX style” may be classified as the first type. Tasks (example: object maintenance and background generation) for which the specific object of the reference data does not need to be spatially aligned in the output of the AI model 100 may be classified as a second type. For example, a task type corresponding to an input prompt such as “Convert the background into a beach” may be classified as the second type. Tasks (example: conversion of object composition and background generation) for which the specific object of the reference data does not need to be spatially aligned in the output of the AI model 100 but deformation of the object is requested may be classified as a third type. For example, a task type corresponding to an input prompt such as “Photo of a man holding a mobile phone” may be classified as the third type. However, the first type to the third type are merely examples, and the disclosure is not limited thereto.

According to one or more embodiments of the disclosure, the task type classifier 102 may classify the type of the task requested by the user 10 by inputting the input prompt from the user 10 to a language model or a large language model.

According to one or more embodiments of the disclosure, the task type classifier 102 may additionally obtain, from the user 10, task information indicating a task or a task type, and may classify a type of the task requested by the user 10, based on the task information. According to one or more embodiments of the disclosure, the task type classifier 102 may classify the type of the task requested by the user 10, based on at least one element or object included in the input prompt or the reference data.

Based on the task type determined by the task type classifier 102, addition of a condition token 104 and position embedding 106 may be performed. The addition of the condition token 104 and the position embedding 106 may be understood as condition embedding according to the task type. For example, according to the task type determined (or classified, extracted) by the task type classifier 102, two condition embeddings of the condition token 104 and the position embedding 106 may be configured.

The condition token 104 appropriate for the determined task type may be added to at least one of the input prompt or the reference data. In one or more embodiments shown in FIG. 1, the task type classifier 102 may classify the type of the task requested by the user 10 as a ‘task type 1’. Accordingly, a condition token for indicating the ‘task type 1’ may be added to at least one of the input prompt or the reference data.

According to one or more embodiments of the disclosure, the condition token 104 may be configured to be task-specific. The condition token 104 may be a text prompt or a token for indicating a task type determined by the task type classifier 102. For example, based on that the task type determined by the task type classifier 102 is the ‘task type 1,’ the condition token 104 may be configured as the same form token as ‘[task type 1]’.

According to one or more embodiments of the disclosure, the condition token 104 may be added to the beginning or the start of the input prompt. For example, the input prompt to which the condition token 104 is added may have the form of ‘[task type 1] input prompt’. The condition token 104 may be a prefix prompt (or token), but the disclosure is not limited thereto. For example, the condition token 104 may be added to any position in the input prompt or at the end of the input prompt.

According to one or more embodiments of the disclosure, the position embedding 106 according to the determined task type may be performed on the reference data from the user 10. To perform position embedding may mean embedding position information in reference data or adding, to a feature representation of the reference data, position embedding representing the position information. The position embedding may be performed on the reference data by using position offset according to the determined task type. For example, based on that the task type determined by the task type classifier 102 is the ‘task type 1,’ the position embedding 106 may be performed by using ‘position offset 1’ corresponding to the ‘task type 1’. The position offset may vary for each task type. Accordingly, different position information representations may be applied (or added) to the reference data according to each task type.

Inputs, from the user 10, to which the condition token 104 is added and/or the position embedding 106 is applied may be input to the AI model 100. In one or more embodiments shown in FIG. 1, the input prompt having attached thereto a condition token of ‘[task type 1]’ and the reference data being position embedded in ‘position offset 1’ may be input to the AI model 100. The condition token 104 may be used by the AI model 100 to recognize or identify a feature of a task. The position embedding 106 may be used in preventing learning collision (and/or inference collision) for each task. The AI model 100 may perform the task requested by the user 10, based on pre-processed condition embeddings (e.g., the input prompt having attached thereto the condition token 104 and the reference data having applied thereto the position embedding 106). The AI model 100 may generate an output matching an intention of the user 10, and may provide the generated output to the user 10.

According to one or more embodiments of the disclosure, task-specific pre-processing may be performed on at least one input that is input from the user 10. For example, condition embeddings such as addition of the condition token 104 or the position embedding 106 may be performed on at least one of the input prompt or the reference data obtained from the user 10. Without an additional input or additional setting by the user 10, a task type may be automatically classified by the task type classifier 102 and appropriate condition embeddings may be performed, such that the AI model 100 may generate an output via an optimal path. As inputs that are condition embedded for each task are provided to the AI model 100, the AI model 100 may correctly recognize which task among a plurality of tasks is requested by the user 10. Accordingly, a plurality of tasks may be flexibly processed (or performed) on one AI model 100. As a result, an output of the AI model 100 may be improved, usage convenience of the user 10 may be enhanced, and scalability of the AI model 100 may be increased. In addition, as a plurality of tasks are flexibly processed (or performed) on one AI model 100, a time taken to offload or load a plurality of AI models may be reduced. For example, as one AI model 100 is capable of processing a plurality of tasks, offloading of a plurality of AI models respectively for the plurality of tasks to memory may be omitted. Accordingly, a response time of the AI model 100 may be improved, and also, a user experience may be enhanced. In addition, as one AI model 100 is capable of processing a plurality of tasks, the number of AI models to be stored in an electronic device may be reduced, and as a result, a storage space for storing the AI models may be reduced.

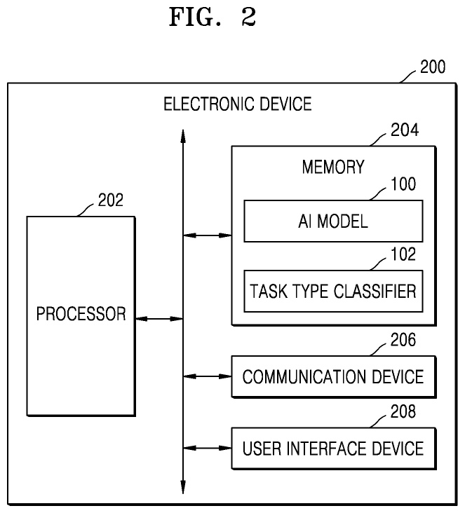

FIG. 2 is a block diagram of an electronic device 200 according to one or more embodiments of the disclosure.

Referring to FIG. 2, the electronic device 200 may include a processor 202, memory 204, a communication device 206, and a user interface device 208. FIG. 2 illustrates only some elements for describing functions and/or operations of the electronic device 200, and elements included in the electronic device 200 are not limited to what are shown in FIG. 2. The configuration of the electronic device 200 shown in FIG. 2 is merely an example, and an example of an electronic device which performs one or more embodiments of the disclosure is not limited to the configuration shown in FIG. 2. According to one or more embodiments of the disclosure, one or more elements shown in FIG. 2 may be deleted or changed, or additionally or alternatively, elements not shown in FIG. 2 may be added to the electronic device 200. All or some of the processor 202, the memory 204, the communication device 206, and the user interface device 208 may be implemented in the form of one chip.

The processor 202 may be an element for controlling a series of processes for causing the electronic device 200 to operate according to embodiments to be described below. Referring to FIG. 2, the processor 202 is shown as one element, but the disclosure is not limited thereto. For example, the processor 202 may be configured as one or more processors. One or more processors included in the processor 202 may be circuitry such as a system on chip (SoC), an integrated circuit (IC), etc. The one or more processors included in the processor 202 may each be a general-purpose processor such as a central processing unit (CPU), a micro processor unit (MPU), an application processor (AP), a digital signal processor (DSP), or the like, a graphics-dedicated processor such as a graphics processing unit (GPU), a vision processing unit (VPU) or the like, an AI-dedicated processor such as a neural processing unit (NPU), or a communication-dedicated processor such as a communication processor (CP). When the one or more processors included in the processor 202 are each an AI-dedicated processor, the AI-dedicated processor may be designed in a hardware structure specialized for processing a particular AI model.

The processor 202 may include various types of processing circuitry and/or a plurality of processors. In some embodiments of the disclosure, a ‘processor’ may include at least one processor, and additionally or alternatively, may include various types of processing circuitry. The one or more processors individually and/or collectively may be configured to perform various functions described in the disclosure in a distributed manner. As used herein, a ‘processor,’ ‘at least one processor,’ and ‘one or more processors’ may be configured to perform various functions. However, these terms may cover, without limitation, a situation where one processor performs some functions and other processor(s) perform other functions, and a situation where a single processor may perform all functions. In addition, the at least one processor may include a combination of processors that perform the disclosed various functions in a distributed manner. The at least one processor individually or collectively may execute program instructions to accomplish or perform various functions.

The processor 202 may control all operations of the electronic device 200. Additionally or alternatively, the processor 202 may control the electronic device 200 to perform at least some of the operations according to one or more embodiments of the disclosure described below. For example, the processor 202 may transmit and/or receive a signal to and/or from an external source via the communication device 206. The processor 202 may write data to the memory 204 and may read data written to the memory 204. For example, the processor 202 may execute one or more instructions of a program stored in the memory 204 so as to process data according to a predefined operation rule or an AI model (e.g., the AI model 100). Accordingly, the processor 202 may perform operations to be described in embodiments of the disclosure. In the disclosure, operations described as being performed by the electronic device 200 or the elements 202, 204, 206, and 208 included in the electronic device 200 may be understood as being performed by the processor 202 unless otherwise described.

The memory 204 may store instructions, data structures, and/or program codes which are readable by the processor 202. The memory 204 may store (or load) a program or at least one instruction for performing operations according to the following embodiments of the disclosure. The memory 204 may provide the stored data to the processor 202, in response to a request from the processor 202. For example, the memory 204 may store data such as basic programs, application programs, and configuration information for the operation of the electronic device 200. In one or more embodiments of the disclosure, the memory 204 may store instructions that, when executed by the processor 202 individually or collectively, cause the electronic device 200 to perform at least some of the operations of the electronic device 200 to be described below. For example, the processor 202 may execute one or more instructions or codes stored in the memory 204 to perform at least some of the operations of the electronic device 200 described in the disclosure.

The memory 204 may include at least one of a flash memory, a hard disk, a multimedia card micro-type memory, or a card-type memory (or storage medium). For example, the memory 204 may include non-volatile memory including at least one of read-only memory (ROM), electrically erasable programmable read-only memory (EEPROM), programmable read-only memory (PROM), magnetic memory, magnetic disk, or optical disk, and/or volatile memory such as dynamic random access memory (DRAM) and/or static random access memory (SRAM).

According to one or more embodiments of the disclosure, the memory 204 may store one or more instructions, data structures, and/or program codes for executing the AI model 100 and/or the task type classifier 102 of FIG. 1. For example, the electronic device 200 may additionally include a storage device (example: hard disk or non-volatile memory device) configured to store the one or more instructions, the data structures, and/or the program codes for executing the AI model 100 and/or the task type classifier 102. The one or more instructions, the data structures, and/or the program codes which are stored in the storage device so as to execute the AI model 100 and/or the task type classifier 102 may be loaded to the memory 204. The AI model 100 and/or the task type classifier 102 which are loaded to the memory 204 may be executed by the processor 202. When the AI model 100 and/or the task type classifier 102 are executed by the processor 202, the electronic device 200 may perform at least one of operations to be described below.

According to one or more embodiments of the disclosure, the electronic device 200 may store a plurality of AI models. The electronic device 200 may identify an output type (e.g., text, an image, or audio) desired by the user 10. The electronic device may load, to the memory 204, one or more AI models among the plurality of AI models which are trained to generate an output type desired by the user 10.

According to one or more embodiments of the disclosure, an AI model (e.g., AI model 100) may include an input encoder, at least one neural network model, and an output decoder. The input encoder may convert original data understandable to humans into numerical data or numerical vectors processible by the neural network model. Encoding performed by the input encoder may be referred to as feature encoding. The at least one neural network model may receive the numerical data converted by the input encoder. The at least one neural network model may perform inference about the received numerical data. The at least one neural network model may output a result of the inference. The output decoder may convert the output of the at least one neural network model into a final output understandable to humans.

The communication device 206 may be an element for transmitting/receiving signals (e.g., control commands, data, etc.) to/from an external device by wire or wirelessly. The communication device 206 may be implemented to include a communication chipset that supports various communication protocols. The communication device 206 may receive a signal from an external source and may provide the signal to the processor 202. The communication device 206 may transmit a signal provided from the processor 202 to an external source. The electronic device 200 may communicate with external devices via the communication device 206.

The user interface device 208 may include an input interface and/or an output interface for interacting with a user of the electronic device 200. For example, the user interface device 208 may include the input interface for receiving at least one of various inputs such as a command, a request, information, or data from the user of the electronic device 200. The input interface may include various input devices such as a touchscreen, a keyboard, and/or a microphone. The user interface device 208 may include the output interface for providing, to the user, an execution result of an operation or a state of the electronic device 200, in response to a command from the user. The output interface may include various output devices such as a display apparatus and/or a speaker.

According to one or more embodiments of the disclosure, the user interface device 208 may indicate the display apparatus. The user interface device 208 may display, on the display apparatus, a set of one or more user interface (UI) elements that configure a UI. The user interface device 208 may obtain an input from the user 10 with respect to one UI element displayed on the display apparatus.

According to one or more embodiments of the disclosure, the electronic device may obtain an input prompt from the user via the user interface device 208. The electronic device 200 may perform a task indicated by the input prompt. The electronic device 200 may provide, to the user, a result (e.g., a response to a question included in the input prompt, data edited in response to a request in the input prompt, etc.) of the task via the user interface device 208.

According to one or more embodiments of the disclosure, the electronic device 200 may additionally obtain reference data from the user via the user interface device 208. Based on the reference data, the electronic device 200 may perform the task indicated by the input prompt. The electronic device 200 may provide, to the user, a result of the task based on the reference data via the user interface device 208.

According to one or more embodiments of the disclosure, the electronic device 200 may additionally obtain task information from the user via the user interface device 208. The task information may represent (or indicate) a task or a type of the task to be performed by the electronic device 200. Based on the task information, the electronic device 200 may identify a type of the task requested by the user. Based on the identified type of the task, the electronic device 200 may perform the task requested by the user. The electronic device may provide, to the user, a result of the task via the user interface device 208.

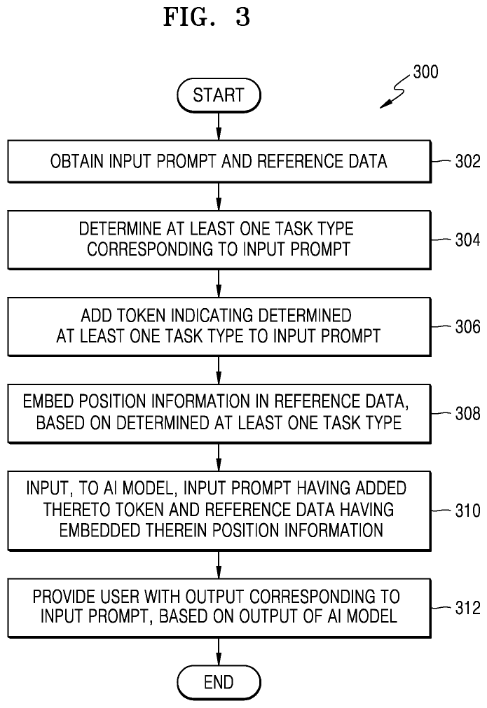

FIG. 3 illustrates a flowchart of a method 300 according to one or more embodiments of the disclosure.

Referring to FIG. 3, the method 300 may include operations 302, 304, 306, 308, 310, and 312. The method 300 may be performed by the electronic device 200 of FIG. 2. However, the disclosure is not limited thereto, and operations 302, 304, 306, 308, 310, and 312 may be performed solely by any electronic device or cooperatively by a plurality of electronic devices. The method 300 according to one or more embodiments of the disclosure is not limited to FIG. 3. For example, the method 300 may omit any one of operations shown in FIG. 3, and additionally or alternatively, may further include operation(s) not shown in FIG. 3. According to one or more embodiments of the disclosure, an order of at least some of operations 302, 304, 306, 308, 310, and 312 may be changed.

In operation 302, the electronic device 200 may obtain an input prompt and reference data. For example, the electronic device 200 may obtain an input prompt and reference data from a user via the user interface device 208. Additionally or alternatively, the electronic device 200 may obtain, from an external device via the communication device 206, the input prompt and reference data of the user which are obtained by the external device.

In operation 304, the electronic device 200 may determine at least one task type corresponding to the input prompt. For example, the electronic device 200 may determine the at least one task type corresponding to the input prompt, by using the task type classifier 102. By using the task type classifier 102, the electronic device 200 may identify a target task of the input prompt. The electronic device 200 may determine a task type of the identified target task.

According to one or more embodiments of the disclosure, the task type classifier 102 may include a language model trained to classify a target task of a given prompt to at least one type. The input prompt from the user may be input to the language model of the task type classifier 102. Based on an output of the language model, the at least one task type corresponding to the input prompt may be determined.

According to one or more embodiments of the disclosure, the task type classifier 102 may obtain task information indicating the target task of the input prompt from the user. Based on the task information, the task type classifier 102 may determine at least one type of the target task of the input prompt.

According to one or more embodiments of the disclosure, the task type classifier 102 may identify at least one object included in the reference data or the at least one object included in the input prompt. Based on the identified at least one object, the task type classifier 102 may determine the at least one task type corresponding to the input prompt.

In operation 306, the electronic device 200 may add, to the input prompt, a token indicating the at least one task type determined in operation 304. The electronic device 200 may insert, into the input prompt, the token indicating the at least one task type corresponding to the input prompt. For example, the electronic device 200 may convert the input prompt into a token sequence including at least one token. The electronic device 200 may add, to the converted token sequence, the token indicating the at least one task type corresponding to the input prompt. Accordingly, the input prompt may comprise the token. In one or more embodiments, ‘addition of any token to an input prompt’ may be understood that any token is added to a token sequence corresponding to the input prompt.

According to one or more embodiments of the disclosure, the electronic device 200 may insert the token indicating the at least one task type corresponding to the input prompt into the input prompt or the start, the middle, or the end of the token sequence corresponding to the input prompt. For example, by tokenizing the input prompt, the electronic device 200 may obtain the token sequence representing the input prompt. The electronic device 200 may insert the token indicating the at least one task type corresponding to the input prompt into the start or the end of the obtained token sequence or between any two tokens in the token sequence.

According to one or more embodiments of the disclosure, determining of at least one task type corresponding to an input prompt may include determining a first task type and a second task type corresponding to the input prompt. For example, with respect to one input prompt, a plurality of task types including a first task type and a second task type may be determined. Adding of a toke indicating at least one determined task type to an input prompt may include adding of a plurality of tokens respectively indicating a plurality of task types to the input prompt. For example, a first token indicating a first task type and a second token indicating a second task type may be added to the input prompt.

In operation 308, the electronic device 200 may embed, based on the determined at least on task type, position information in at least one feature representing the reference data. The electronic device 200 may combine task-specific position embedding with each of the at least one feature of the reference data, by using an offset corresponding to the at least one task type corresponding to the input prompt. For example, the electronic device 200 may insert, into the reference data, the position information to which the offset corresponding to the at least one task type corresponding to the input prompt is applied (or added). Accordingly, the reference data may comprise the position information. The at least one feature representing the reference data having embedded therein the position information may also be referred to as the embedded reference data.

According to one or more embodiments of the disclosure, the position information may include a position value indicating a position of each feature on a sequence or a structure of features representing the reference data. The position information may include a position value indicating a position on original reference data of each feature.

According to one or more embodiments of the disclosure, performing of position embedding on reference data may include encoding of the reference data so as to obtain at least one feature representing the reference data. For example, the electronic device 200 may decompose the reference data into at least one unit (e.g., tokens or patches). The electronic device 200 may convert the at least one unit decomposed from the reference data into one or more embeddings (or embedding vectors).

In one or more embodiments, performing of position embedding on reference data may include embedding of information indicating a position of each feature on the reference data or a position of each feature in a feature vector representing the reference data with respect to at least one feature representing the reference data, by using a position offset corresponding to the at least one task type determined in operation 304. For example, the electronic device 200 may add, with respect to each of the at least one feature, a position embedding vector to which the position offset corresponding to the at least one task type determined in operation 304 is applied. The position embedding vector may include information indicating a position of each feature in the reference data. Applying of a position offset to a position embedding vector may include adding of a position offset vector to the position embedding vector. The position offset vector may be a vector having a position offset value of a value corresponding to at least one determined task type.

According to one or more embodiments of the disclosure, determining of at least one task type corresponding to an input prompt may include determining of a first task type and a second task type corresponding to the input prompt. For example, a plurality of task types including the first task type and the second task type may be determined with respect to one input prompt. Performing of position embedding on reference data may include adding of position information to at least one feature representing the reference data, by using a plurality of position offsets respectively corresponding to a plurality of task types. For example, performing of the position embedding on the reference data may include adding of the position information to the at least one feature representing the reference data, by using a first position offset corresponding to a first task type and a second position offset corresponding to a second task type.

In operation 310, the electronic device 200 may input, to the AI model 100, the input prompt to which the token is added in operation 306 and the reference data in which the position information is embedded in operation 308. The AI model 100 may generate an output corresponding to the input prompt, based on condition embeddings via operations 306 and 308, the input prompt, and the reference data. The token added to the input prompt and the position information embedded in the reference data may instruct the AI model 100 the task type to be performed. Based on the token added to the input prompt and the position information embedded in the reference data, the single AI model 100 may flexibly process various types of tasks.

According to one or more embodiments of the disclosure, the electronic device 200 may obtain one or more object areas in the reference data associated with the target task of the input prompt. The electronic device 200 may obtain an input of the user 10 for selecting a specific area in the reference data. The electronic device 200 may provide the AI model 100 with information about the one or more object areas which is obtained from the user 10. Based on the information about the object areas, the AI model 100 may perform the task. In one or more embodiments, the electronic device 200 may crop, from the reference data, the one or more object areas selected by the user 10. The electronic device 200 may use a cropped image as reference data when executing the AI model 100.

In operation 312, the electronic device 200 may provide an output corresponding to the input prompt to the user 10, based on the output of the AI model 100. The output of the AI model 100 may represent a result of performing, by the AI model 100, the task requested by the input prompt. The electronic device 200 may generate a final output corresponding to the input prompt, by using the output of the AI model 100. The electronic device 200 may provide the user with the final output via the user interface device 208.

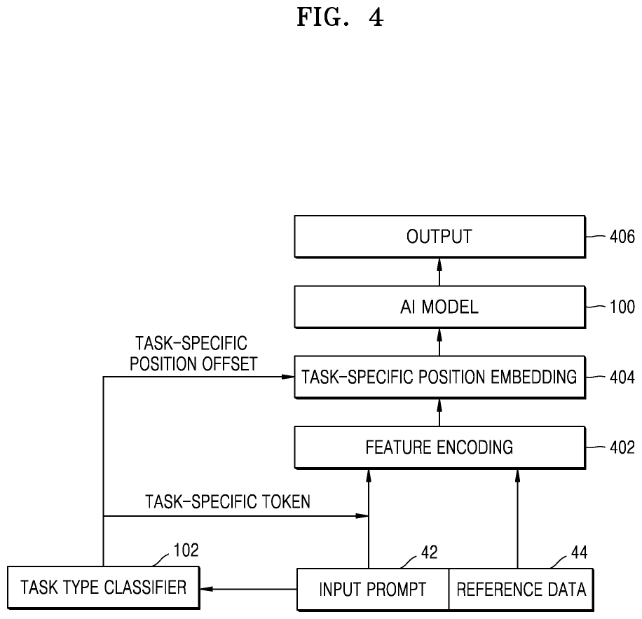

FIG. 4 illustrates an input prompt 42 and reference data 44 being input to the AI model 100, according to one or more embodiments of the disclosure.

Referring to FIG. 4, the electronic device 200 may receive the input prompt 42 and the reference data 44 from the user 10. The input prompt 42 and the reference data 44 may be pre-processed via feature encoding 402 and task-specific position embedding 404. The pre-processed input prompt 42 and reference data 44 may be input to the AI model 100.

The input prompt 42, or a combination of the input prompt 42 and the reference data 44, may be input to the task type classifier 102. The task type classifier 102 may determine a task type requested by the user 10, based on the input prompt 42 or the combination of the input prompt 42 and the reference data 44.

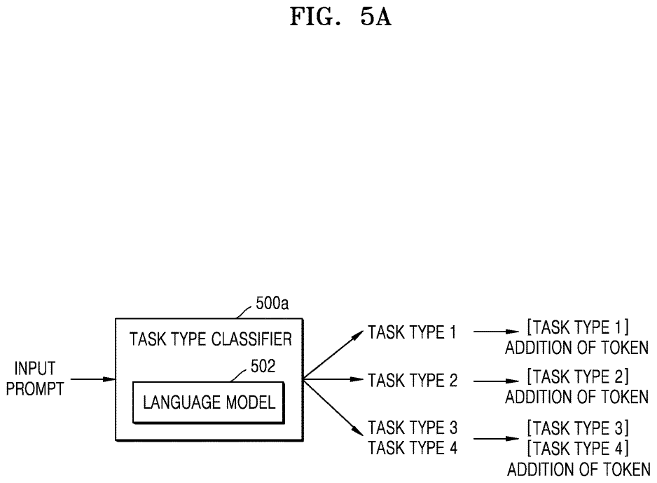

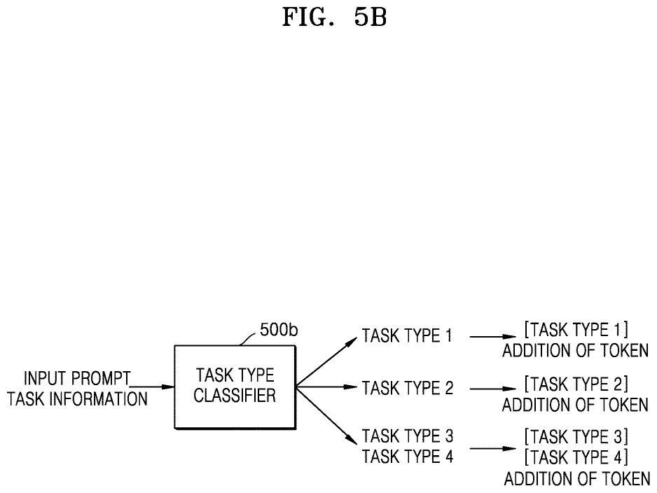

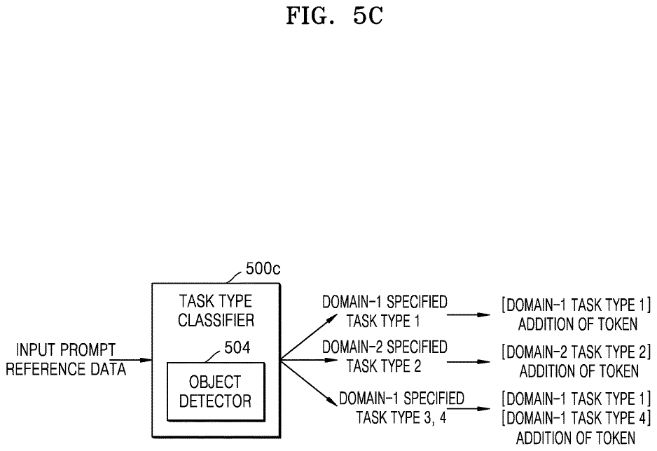

A task-specific token indicating the task type determined by the task type classifier 102 may be inserted into the input prompt 42. For example, the task-specific token may be added to the front of the input prompt 42. In order to obtain at least one feature representing the input prompt 42 to which the task-specific token is added, the input prompt 42 to which the task-specific token is added may be encoded (e.g., feature encoding 402). For example, the electronic device 200 may encode the input prompt 42 to which the task-specific token is added, by using a text encoder. Accordingly, the at least one feature representing the input prompt 42 to which the task-specific token is added, e.g., at least one text embedding, may be obtained. Particular operations of the task type classifier 102 will be described with reference to FIGS. 5A, 5B, and 5C.

In order to obtain at least one feature representing the reference data 44, the reference data 44 may be encoded (e.g., feature encoding 402). The electronic device 200 may encode the reference data 44 by using an encoder corresponding to a modality type of the reference data 44. For example, based on the reference data 44 being text data, the electronic device 200 may encode the reference data 44 by using the text encoder. Based on the reference data 44 being audio data, the electronic device 200 may encode the reference data 44 by using an audio encoder. Based on the reference data 44 being image data, the electronic device 200 may encode the reference data 44 by using an image encoder. Accordingly, the at least one feature representing the reference data 44, e.g., at least one text, audio, or image embedding, may be obtained.

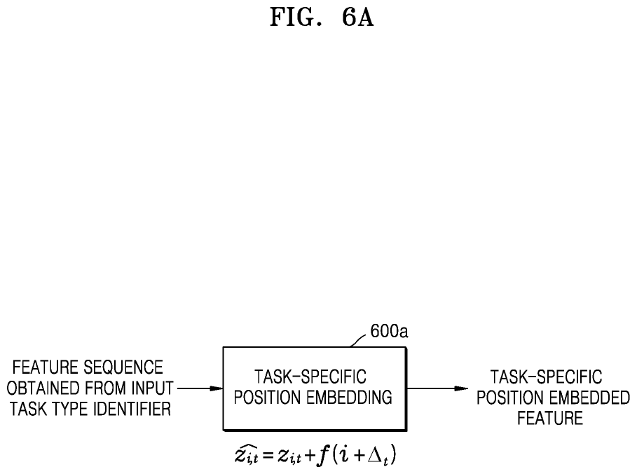

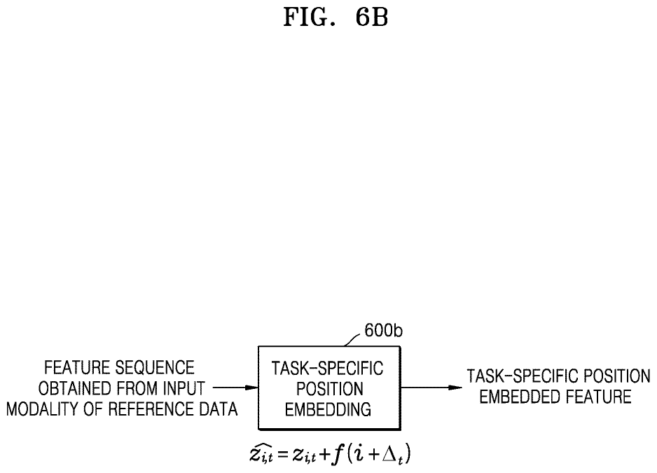

With respect to the at least one feature representing the reference data 44, a position of each feature in the reference data 44 may be embedded by using a task-specific position offset corresponding to the task type determined by the task type classifier 102 (e.g., task-specific position embedding 404). For example, the electronic device 200 may encode coordinates on at least one unit of reference data 44 decomposed from the reference data 44. A task-specific position offset may be used in encoding the coordinates. For example, the task-specific position offset may be added to values of at least one coordinate of each unit. Accordingly, at least one position embedding representing position information of each unit on the reference data 44 may be obtained, by using the task-specific position offset. The at least one position embedding may be combined with a corresponding feature. A feature combined with position embedding may be referred to as a task-specific position embedded feature. Particular operations of the task-specific position embedding 404 will be described in detail with reference to FIGS. 6A and 6B.

At least one task-specific position embedded feature and at least one feature representing the input prompt 42 having added thereto a task-specific token, which represent the reference data 44, may be input to the AI model 100. The AI model 100 may provide an output 406 in response to the inputs. According to one or more embodiments of the disclosure, the AI model 100 may perform a task indicated by the input prompt 42 on the reference data 44 or based at least partially on the reference data 44, according to the task type determined by the task type classifier 102. The output 406 may also be referred to as a product of the AI model 100. In one or more embodiments, the output 406 may indicate a result obtained by processing the product of the AI model 100 to user-understandable representation.

In one or more embodiments, the task-specific position embedding 404 may be applied to the at least one feature representing the input prompt 42 to which the task-specific token is added. For example, during feature encoding 402, the input prompt 42 to which the task-specific token is added may be decomposed into at least one token, and the tokens may be vectorized. Afterward, for the task-specific position embedding 404, the electronic device 200 may encode a position value indicating a position of each token on the input prompt 42 (e.g., an index of each token in a token sequence of the input prompt 42). A task-specific position offset may be used in encoding a position value. For example, the task-specific position offset may be added to the position value. Accordingly, at least one position embedding representing position information of each token on the input prompt 42 may be obtained. The obtained at least one position embedding may be combined with a corresponding feature obtained via corresponding feature encoding 402. The at least one task-specific position embedded feature may be provided to the AI model 100.

FIGS. 5A, 5B, and 5C illustrate task type classifiers 500a, 500b, and 500c according to one or more embodiments of the disclosure.

The task type classifier 102 of FIG. 1 may be implemented as the task type classifier 500a of FIG. 5A, the task type classifier 500b of FIG. 5B, and/or the task type classifier 500c of FIG. 5C. Referring to FIG. 5A, the task type classifier 500a may include a language model 502. The language model 502 may be trained to select, among at least one pre-defined task type, at least one task type corresponding to a task or a goal which is indicated by an input text. For example, the language model 502 may analyze an input prompt. The language model 502 may identify a goal of the input prompt, and may identify at least one task to achieve the identified goal. The language model 502 may determine at least one task type corresponding to the identified at least one task. The language model 502 may output the determined at least one task type. In order to indicate at least one task type determined by the language model 502, at least one task-specific token may be added to the input prompt.

For example, in response to the input prompt being input to the language model 502, determination that the task indicated by the input prompt corresponds to ‘task type 1’ may be output from the language model 502. Accordingly, a token ‘[task type 1]’ indicating ‘task type 1’ may be added to the input prompt. Based on determination that the task indicated by the input prompt corresponds to ‘task type 2’ is output from the language model 502, a token ‘[task type 2]’ indicating ‘task type 2’ may be added to the input prompt.

The task indicated by the input prompt may be a combination of a plurality of different types of tasks. Accordingly, the language model 502 may output determination that the task indicated by the input prompt corresponds to the plurality of task types. For example, the language model 502 may output determination that the task indicated by the input prompt corresponds to both ‘task type 3’ and ‘task type 4’. Accordingly, a token ‘[task type 3]’ indicating ‘task type 3’ and a token ‘[task type 4]’ indicating ‘task type 4’ may be added to the input prompt.

Referring to FIG. 5B, an input prompt along with task information may be added to the task type classifier 500b. The task information may include information about a task or a task type that the user 10 attempts to perform via the input prompt, which is input from the user 10. For example, the user 10 may input the task information with the input prompt and reference data to the electronic device 200, the task information including a desired task or a desired task type. The electronic device 200 may input, to the task type classifier 500b, the input prompt with the task information input from the user 10.

The task type classifier 500b may determine at least one task type corresponding to the input prompt, based on the task information input from the user 10. The task type classifier 500b may identify at least one task included in the task information, and may determine at least one task type corresponding to the at least one task included in the task information. The task type classifier 500b may identify at least one task type included in the task information, and may determine at least one task type identified as at least one task type corresponding to the input prompt. In the similar manner described with reference to FIG. 5A, at least one token (e.g., ‘[task type 1],’ ‘[task type 2],’ or a combination of ‘[task type 3]’ and ‘[task type 4]’) indicating the at least one task type determined by the task type classifier 500b may be added to the input prompt.

Referring to FIG. 5C, an input prompt and reference data may be input to the task type classifier 500c. The task type classifier 500c may include an object detector 504. The object detector 504 may detect at least one object from at least one of the reference data or the input prompt. Based on the detected at least one object, the task type classifier 500c may determine at least one task type corresponding to the input prompt.

According to one or more embodiments of the disclosure, the task type classifier 500c may select task types specified for a particular domain corresponding to the input prompt. For example, the AI model 100 may be trained to perform a plurality of tasks over various domains. A domain may be defined based on various features of data to be processed by the AI model 100, the features including input data to be processed by the AI model 100 or a distribution, a feature, a source, or theme of the task to be processed by the AI model 100. For example, the AI model 100 may support domains, such as a final domain, a medical domain, a legal domain, or a technical domain, defined according to a task or input data. The AI model 100 may support domains, such as a domain for each of one or more electronic devices communicating with the electronic device 200, defined according to a type of a device associated with a task to be performed by the AI model 100. The AI model 100 may be trained to perform various tasks over a plurality of domains.

Based on the input prompt from the user 10, the task type classifier 500c may identify a domain associated with a task desired by the user 10 and/or a domain associated with the reference data input from the user 10. Based on the identified domain, the task type classifier 500c may determine at least one task type specified for the corresponding domain. For example, the task type classifier 500c may detect at least one object from at least one of the reference data or the input prompt, and may identify a domain corresponding to the input prompt, based on the detected at least one object. The task type classifier 500c may determine at least one among at least one task type specified for the identified domain (or associated with the identified domain) as the task type corresponding to the input prompt.

For example, the task type classifier 500c may determine the domain corresponding to the input prompt as ‘domain 1’ based at least partially on the at least one object detected from the input prompt or the at least one object detected from the reference data. Based at least partially on the at least one object detected from the input prompt or the at least one object detected from the reference data, the task type classifier 500c may determine ‘domain 1 specified task type 1’ as the task type corresponding to the input prompt among task types associated with ‘domain 1’. Accordingly, a token ‘[domain 1 specified task type 1]’ indicating ‘domain 1 specified task type 1’ may be input to the input prompt.

In a similar manner, the task type classifier 500c may determine a domain corresponding to the input prompt as ‘domain 2,’ based at least partially on the at least one object detected from the input prompt or the at least one object detected from the reference data. Based at least partially on the at least one object detected from the input prompt or the at least one object detected from the reference data, the task type classifier 500c may determine ‘domain 2 specified task type 2’ as a task type corresponding to the input prompt among task types associated with ‘domain 2’. Accordingly, a token ‘[domain 2 specified task type 2]’ indicating ‘domain 2 specified task type 2’ may be added to the input prompt.

The task type classifier 500c may select a plurality of task types corresponding to the input prompt. For example, based at least partially on the at least one object detected from the input prompt or the at least one object detected from the reference data, the task type classifier 500c may determine ‘domain 1 specified task type 3’ and ‘domain 1 specified task type 4’ as a plurality of task types corresponding to the input prompt among the task types associated with ‘domain 1’. Accordingly, a token ‘[domain 1 specified task type 3]’ indicating ‘domain 1 specified task type 3’ and a token ‘[domain 1 specified task type 4]’ indicating ‘domain 1 specified task type 4’ may be added to the input prompt.

In one or more embodiments, the task type classifier 500c may identify a plurality of domains corresponding to the input prompt or the reference data. For each of the plurality of domains, the task type classifier 500c may select at least one task type specified for each domain. Accordingly, at least one token for indicating at least one selected task type may be added to the input prompt.

According to one or more embodiments of the disclosure, the task type classifier 102 of FIG. 1 may be implemented to perform any combination of operations of the task type classifier 500a of FIG. 5A, operations of the task type classifier 500b of FIG. 5B, and/or operations of the task type classifier 500c of FIG. 5C which are described herein. For example, the task type classifier 102 includes the language model 502, and in response to task information being given, may identify at least one task type based on the task information.

In one or more embodiments, the language model 502 may be trained to infer, in response to an input text prompt, at least one domain associated with the input prompt and at least one task type specified for each domain. At least one token indicating at least one domain-specific task type inferred by the language model 502 may be added to the input prompt.

In one or more embodiments, at least one domain corresponding to the input prompt may be identified based on the task information. For example, the task type classifier 500b may identify at least one domain associated with the input prompt and at least one task type specified for each domain, based on at least one of information about a task or information about a task type included in the task information. At least one token indicating the identified at least one domain-specified task type may be added to the input prompt.

FIGS. 6A and 6B illustrate task-specific position embeddings 600a and 600b, according to one or more embodiments of the disclosure.

As described above with reference to FIG. 4, the electronic device 200 may apply the task-specific position embedding 404 to at least one of the input prompt 42 or the reference data 44, based on the at least one task type determined by the task type classifier 102. The task-specific position embedding 404 may be configured as the task-specific position embedding 600a of FIG. 6A and/or the task-specific position embedding 600b of FIG. 6B.

Referring to FIGS. 6A and 6B, a feature sequence may include at least one feature obtained from an input such as the input prompt 42 having attached thereto the task-specific token or the reference data 44. As described above with reference to FIG. 4, at least one feature may be obtained from the input prompt 42 having attached thereto the task-specific token, and at least one feature may be obtained from the reference data 44, via feature encoding 402. The feature sequence may be a set of at least one feature obtained from the input prompt 42 having attached thereto the task-specific token or a set of at least one feature obtained from the reference data 44.

A task type identifier may indicate at least one task type determined by the task type classifier 102. A task type identifier may be used to identify a task type so as to add task-specific position embeddings 600a and/or 600b to an input feature. According to task types, different position offsets may be used in applying of position embedding.

Referring to FIG. 6A, based on the task type identifier, the task-specific position embedding 600a may be applied to a given feature sequence. The electronic device 200 may encode position information representing a position of each feature in the feature sequence by using a position offset, and thus, may generate position embedding. Position information about a random feature may include at least one position value indicating a feature position in a sequence or at least one position value indicating a feature position on an input (e.g., the input prompt 42 having attached thereto the task-specific token or the reference data 44). Position values may include at least one coordinate value or an index value of a token in at least one sequence.

A position offset may vary for each task type. In one or more embodiments, in order to generate position embedding, based on a task type identifier indicating a task type t, a position offset Δₜ specified for the task type t (e.g., corresponding to the task type t or designated for the task type t) may be used in generating position embedding. According to one or more embodiments of the disclosure, a position offset range for each task type may be defined. Accordingly, any value within a position offset range corresponding to a task type indicated by the task type identifier may be used as a position offset to be used in generating position embedding.

With respect to the task type identifier indicating the task type t and coordinates (or index) i for any axis (e.g., x axis) of a given feature sequence, a value (or a feature or a feature vector) [symbol] at a position i in a feature sequence to which the task-specific position embedding 600a is applied may be expressed as Equation 1.

$$\hat{{z}_{i , t}} = {z}_{i , t} + f ( i + {Δ}_{t} ) \qquad [ Equation 1 ]$$

In Equation 1, Zit may indicate a value at a position i in a given feature sequence. For example, Zit may indicate a value of a feature (or feature vector) at the position i in the given feature sequence. f(⋅) may indicate position embedding generated based on a position value. Referring to Equation 1, a position offset Δₜ specified for the task type t may be added to the position i. As a position offset is applied, position embedding f may be generated based on a position value i+Δₜ to which the position offset Δₜ is added. The position embedding f(i+Δₜ) generated based on the position value i+Δₜ may be combined with z_{i,t}. Accordingly, a task-specific position embedded feature sequence including [symbol] may be generated.

According to one or more embodiments of the disclosure, the task type identifier may indicate a plurality of task types. For example, the task type identifier may indicate a first task type and a second task type. A plurality of position offsets corresponding to the plurality of task types may be used in generating at least one position embedding for a feature sequence. The plurality of position offsets may be respectively applied to a plurality of axes. For example, a first position offset Δ₁ specified for the first task type may be used in generating position embeddings for x-coordinate. A second position offset Δ2 specified for the second task type may be used in generating position embeddings for y-coordinate. A value [symbol] on coordinates (x, y) of a feature sequence position embedded by using the first position offset Δ₁ and the second position offset Δ₂ may be expressed as Equation 2. In Equation 2, z_{x,y} may indicate a value on the coordinates (x, y) of the feature sequence.

$$\hat{{z}_{x , y}} = {z}_{x , y} + f ( x + {Δ}_{1} , y + {Δ}_{2} ) \qquad [ Equation 2 ]$$

According to one or more embodiments of the disclosure, based on a plurality of tasks being indicated by a task type identifier, the electronic device 200 may extend a dimension of position information. For example, based on reference data being text data, a feature sequence may be a one-dimensional sequence of text tokens. Accordingly, the position information may include a one-dimensional index value (i.e., x-coordinate) of each token in the feature sequence. Based on the plurality of tasks being indicated by the task type identifier, the electronic device 200 may extend the position information to two-dimension. For example, the electronic device 200 may pad y-coordinate with 0.

Referring to FIG. 6B, the task-specific position embedding 600b may be applied to a given feature sequence, based on a task type identifier and a modality of reference data. The electronic device 200 may identify the modality of the reference data. For example, the electronic device 200 may obtain modality information indicating the modality of the reference data from the user 10. The electronic device 200 may identify the modality of the reference data, based on the modality information. The electronic device 200 may analyze the modality of the reference data, and based on the analysis, may identify the modality of the reference data.

The electronic device 200 may select a type of an operation (or function) of f for generating position embedding, based on a modality of an input. For example, position embedding may be generated via any one of various operations including a sinusoidal function, rotary position embeddings (RoPE), or a neuran network model trained with respect to generation of position embedding. For each of modalities of reference data supported by the electronic device 200, modality-specific position embedding may be predetermined. For example, it may be predetermined that RoPE is to be used for an image modality. Accordingly, the electronic device 200 may select a specified position embedding scheme according to a modality type of reference data. Accordingly, the electronic device 200 may efficiently process a multi-modal input.

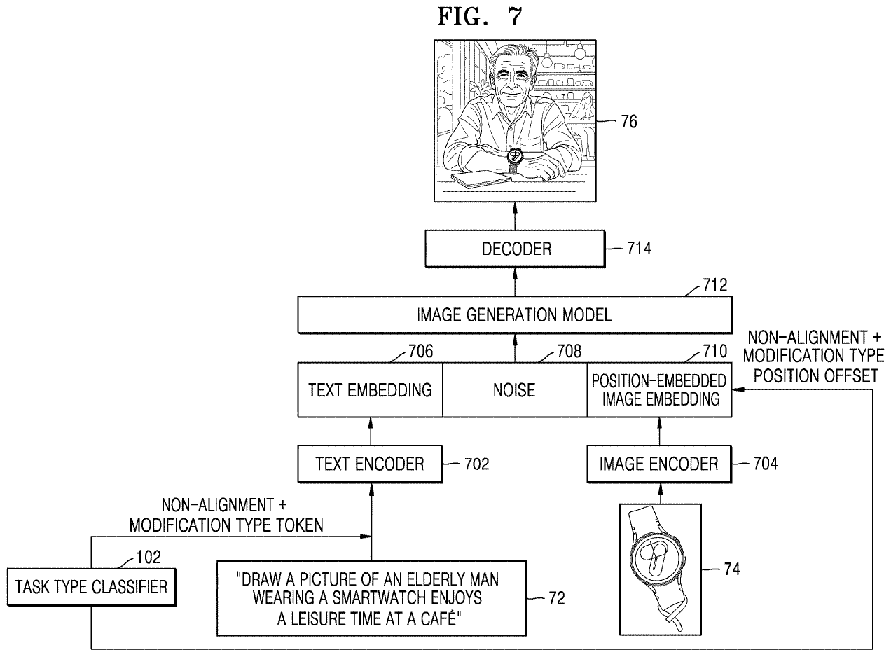

FIG. 7 illustrates a process of generating an output image 76 based on an input prompt 72 and reference data 74, according to one or more embodiments of the disclosure.

Referring to FIG. 7, the electronic device 200 of FIG. 2 may receive the input prompt 72 and the reference data 74 from the user 10. Based on the input prompt 72 and the reference data 74, the electronic device 200 may generate the output image 76 by using an image generation model 712. In a similar manner to that described with reference to FIG. 4, the electronic device 200 may pre-process the input prompt 72 and the reference data 74. The pre-processed input prompt 72 and the pre-processed reference data 74 may be input to the image generation model 712.

In the embodiment shown in FIG. 7, in order to generate the output image 76 based on the input prompt 72 and the reference data 74, the electronic device 200 may execute an image generation AI model based on a diffusion model. The image generation AI model may include a text encoder 702 for converting the input prompt 72 having attached thereto a task-specific token into text embeddings 706. The image generation AI may include a noise generator for generating noise 708. The image generation AI may include an image encoder 704 for converting the reference data 74 into image embeddings. The image generation AI may include a position encoder configured to embed position information to the image embeddings by using a task-specific position offset, and generate position-embedded image embedding 710. The image generation AI may include the image generation model 712 trained to generate a noise vector, based on the text embeddings 706, the noise 708, and the position-embedded image embedding 710. The image generation AI may include a decoder 714 configured to convert an image vector output from the image generation model 712 into the output image 76. The image generation model 712 may be a neural network model trained to generate an image based on an input prompt having attached thereto a task-specific token, random noise, and task-specific position embedded image data.

The input prompt 72 may include a request for a task to be performed by the electronic device 200 based on the reference data 74, such as “Draw a picture of an elderly man wearing a smartwatch enjoys a leisure time at a café”. The reference data 74 may be image data representing an object ‘smartwatch’ included in the input prompt 72.

The input prompt 72, or a combination of the input prompt 72 and the reference data 74, may be input to the task type classifier 102. The task type classifier 102 may determine a task type requested from the user 10, based on the input prompt 72 or the combination of the input prompt 72 and the reference data 74. According to one or more embodiments of the disclosure, as described above with reference to FIGS. 5A, 5B, and 5C, the task type classifier 102 may determine the task type that is requested from the user 10 and is indicated by the input prompt 72.

In one or more embodiments of FIG. 7, a goal indicated by the input prompt 72 may be to convert a composition of a smartwatch illustrated in the center of the reference data 73 into a composition of the smartwatch worn by an elderly man and to generate the background as a café. The task type classifier 102 may identify that the goal indicated by the input prompt 72 is a task of object composition conversion and background generation, and may determine that the identified task is ‘non-alignment+modification’ in which space non-alignment and modification are combined. Accordingly, the task type classifier 102 may determine that the task type corresponding to the input prompt 72 is ‘non-alignment+modification’.

A task-specific token ‘non-alignment+modification type token’ indicating the task type ‘non-alignment+modification’ determined by the task type classifier 102 may be inserted into the input prompt 72. For example, the task-specific token may be added to the front of the input prompt 72. In order to obtain at least one feature representing the input prompt 72 having added thereto the task-specific token, the electronic device 200 may encode the input prompt 72 having added thereto the task-specific token, by using the text encoder 702. Accordingly, the at least one feature representing the input prompt 72 having added thereto the task-specific token, e.g., the at least one text embedding 706, may be obtained.

In order to obtain at least one feature representing the reference data 74, the electronic device 200 may encode the reference data 74 by using the image encoder 704. Accordingly, the at least one feature representing the reference data 74, e.g., at least one position embedding, may be generated. According to one or more embodiments of the disclosure, the image encoder 704 may be a VAE encoder.

With respect to the at least one feature representing the reference data 74, position information may be embedded in image embeddings output from the image encoder 704, by using a task-specific position offset ‘non-alignment+modification type position offset’ corresponding to the task type ‘non-alignment+modification’ determined by the task type classifier 102. For example, the electronic device 200 may encode coordinates of a token (e.g., a pixel or a patch) of the reference data 74 on the reference data 74, the token corresponding to each image embedding. As described above with reference to FIGS. 6A and 6B, the task-specific position offset ‘non-alignment+modification type position offset’ may be used in encoding coordinates. Accordingly, at least one position embedding representing position information of each token on the reference data 74 may be obtained by using the task-specific position offset ‘non-alignment+modification type position offset’. The at least one position embedding may be combined with corresponding image embedding. Accordingly, the at least one position-embedded image embedding 710 may be obtained.

The noise 708 may be randomly-generated noise. For example, the noise 708 may be noise generated based on a predefined seed, by using a random number generator.

The image generation model 712 may be a neural network model trained to generate a noise vector, based on the text embeddings 706, the noise 708, and the position-embedded image embedding 710. The text embeddings 706 and the position-embedded image embedding 710 may be referred to as condition vectors for conditioning an operation of the image generation model 712. The image generation model 712 may predict noise to be removed from the noise 708, based on the text embeddings 706 and the position-embedded image embedding 710, and may remove the predicted noise from the noise 708.

According to one or more embodiments of the disclosure, the image generation model 712 may predict the noise to be removed from an image that includes noise and corresponds to a combination of the position-embedded image embedding 710 and the noise 708. The image generation model 712 may remove the predicted noise from the image including the noise, and may predict again noise to be removed subsequently. For example, the image generation model 712 may convert a composition of the image including the noise and generate the background, based on conditions indicated by the text embeddings 706. Via repetitive noise prediction and removal by the image generation model 712, a latent image vector from which noise has been removed may be obtained. According to one or more embodiments of the disclosure, the image generation model 712 may be trained based on any one among various neural network models including a transformer, UNet, or the like.

The decoder 714 may decode the latent image vector obtained via the image generation model 712. The decoder 714 may convert the latent image vector into the output image 76. The output image 76 may correspond to a result of the task indicated by the input prompt 72. For example, as requested by the input prompt 72, the output image 76 may show an elderly man who is sitting in a café and is wearing the smartwatch of the reference data 74. According to one or more embodiments of the disclosure, the decoder 714 may be a VAE decoder.

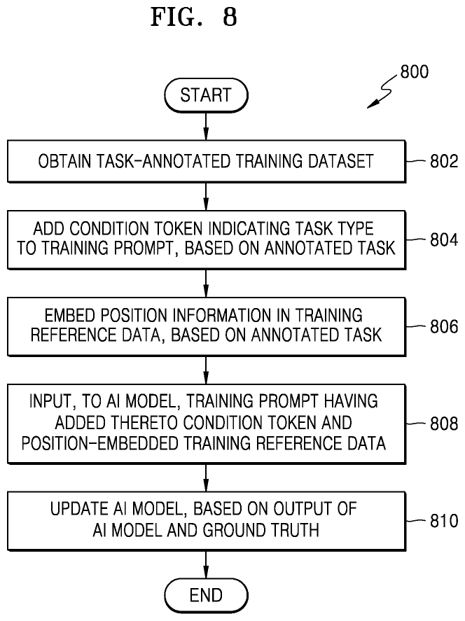

FIG. 8 illustrates a flowchart of a method 800 of training the AI model 100, according to one or more embodiments of the disclosure.

Referring to FIG. 8, the method 800 may include operations 802, 804, 806, 808, and 810. The method 800 may be performed by the electronic device 200 of FIG. 2 or an external electronic device. For example, the external electronic device may configure the AI model 100 via the method 800, and may distribute the AI model 100 to the electronic device 200. However, the disclosure is not limited thereto, and operations 802, 804, 806, 808, and 810 may be performed solely by any electronic device or cooperatively by a plurality of electronic devices. The method 800 according to one or more embodiments of the disclosure is not limited to FIG. 8. For example, the method 800 may omit any one of operations shown in FIG. 8, and In one or more embodiments, may further include operation(s) not shown in FIG. 8. According to one or more embodiments of the disclosure, an order of at least some of operations 802, 804, 806, 808, and 810 may be changed.

In operation 802, the electronic device 200 may obtain a task-annotated training dataset. A training dataset may include one or more sets of training reference data, a training prompt, task information indicating a task to be performed via the training prompt, and ground truths corresponding to the training reference data and the training prompt. For example, the training dataset may include a first set of training reference data that is image data representing a smartphone, a training prompt indicating “A man and a woman are in an office, focusing on a smartphone,” a task ‘background generation’ to be performed via the training prompt, and ground truths that are image data representing a scene including a man and a woman watching a smartphone in an office. The training data set may include a second set of training reference data that is image data representing a smartwatch, a training prompt indicating “A well-dressed elderly man wearing a smartwatch enjoys a leisure time at a café,” a task ‘composition conversion’ to be performed via the training prompt, and ground truths that are image data representing a scene including an elderly man wearing a smartwatch stares an empty space in a café.

In operation 804, the electronic device 200 may add a condition token indicating a task type to the training prompt, based on an annotated task. The electronic device 200 may determine the task type, based on task information, by using the task type classifier 102. The electronic device 200 may add a condition token indicating the determined task type to the training prompt. For example, the electronic device 200 may add the condition token indicating the determined task type to the training prompt, in a similar manner to those described above with reference to FIGS. 1, 2, 3, and 4.

For example, based on task information indicating the task ‘background generation’ included in the first set, the electronic device 200 may identify the task ‘background generation’ to be performed via the training prompt of the first set. The electronic device 200 may determine a task group or a task type (e.g., a task type ‘non-alignment’) including the task ‘background generation,” as a task type corresponding to the training prompt of the first set. The electronic device 200 may add, to the training prompt, a condition token indicating the determined task type.

For example, based on task information indicating the task ‘composition conversion’ included in the second set, the electronic device 200 may identify the task ‘composition conversion’ to be performed via the training prompt of the second set. The electronic device 200 may determine a task group or a task type (e.g., a task type ‘non-alignment+modification’) including the task ‘composition conversion,’ as a task type corresponding to the training prompt of the second set. The electronic device 200 may add, to the training prompt, a condition token indicating the determined task type.

In operation 806, the electronic device 200 may embed position information in at least one feature representing training reference data, based on the annotated task. The electronic device 200 may determine the task type, based on task information included in the training dataset, by using the task type classifier 102. The electronic device 200 may embed the position information in the training reference data by using a position offset corresponding to the determined task type. For example, in a similar manner to those described above with reference to FIGS. 1, 2, 3, and 4, and FIGS. 6A and 6B, the electronic device 200 may embed the position information in at least one feature representing the training reference data, by using the position offset corresponding to the determined task type.

In operation 808, the electronic device 200 may input, to the AI model 100, a training prompt having added thereto a condition token and position-embedded training reference data. For example, the electronic device 200 may input, to the AI model 100, the training prompt to which the condition token is added in operation 804 and the training reference data position embedded in operation 806. The AI model 100 may generate data, based on the training prompt having added thereto the condition token and the training reference data. The AI model 100 may output the generated data.

In operation 810, the electronic device 200 may update the AI model 100, based on an output of the AI model 100 and ground truth. The electronic device 200 may calculate a loss function, based on the data output from the AI model 100 and the ground truth corresponding to the training data input to the AI model 100. The electronic device 200 may update at least one weight matrix of the AI model 100, based on the calculated loss function.

According to one or more embodiments of the disclosure, the language model 502 of the task type classifier 500a may be trained by using the task-annotated training dataset. For example, the language model 502 may be trained via supervised learning, based on a training prompt and corresponding task information included in the task-annotated training dataset.

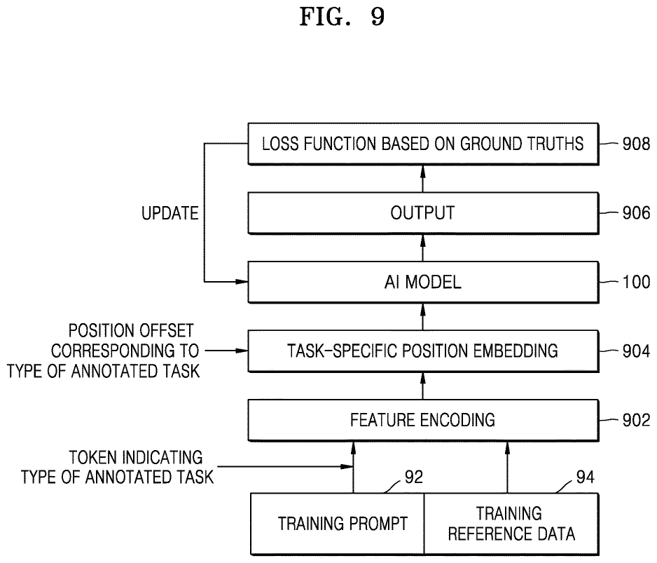

FIG. 9 illustrates the AI model 100 being trained, according to one or more embodiments of the disclosure.

Referring to FIG. 9, the electronic device 200 may train the AI model 100 by using the method 800 of FIG. 8. The electronic device 200 may obtain a training dataset including a training prompt 92, training reference data 94, task information indicating a task to be performed via the training prompt 92, and ground truths corresponding to the training prompt 92 and the training reference data 94. The training prompt 92 and the training reference data 94 may be pre-processed via feature encoding 902 and task-specific position embedding 904. The training prompt 92 and the training reference data 94 which are pre-processed may be input to the AI model 100.

Based on the task information indicating the task to be performed via the training prompt 92, the electronic device 200 may identify a task type annotated with respect to the training prompt 92. The electronic device 200 may add a token indicating the annotated task type to the training prompt 92.

In order to obtain at least one feature representing the training prompt 92 having added thereto the token, the training prompt 92 having added thereto the token may be encoded (feature encoding 902). For example, the electronic device 200 may encode the training prompt 92 having added thereto the token, by using a text encoder. Accordingly, the at least one feature representing the training prompt 92 having added thereto the token, e.g., at least one text embedding, may be obtained.

In order to obtain at least one feature representing the training reference data 94, the training reference data 94 may be encoded (feature encoding 902). The electronic device 200 may encode the training reference data 94 by using an encoder corresponding to a modality type of the training reference data 94. For example, based on the training reference data 94 being text data, the electronic device 200 may encode the training reference data 94 by using the text encoder. Based on the training reference data 94 being audio data, the electronic device 200 may encode the training reference data 94 by using an audio encoder. Based on the training reference data 94 being image data, the electronic device 200 may encode the training reference data 94 by using an image encoder. Accordingly, at least one feature representing the training reference data 94, e.g., one or more texts, audio, or image embeddings, may be obtained.

With respect to the at least one feature representing the training reference data 94, a position of each feature in the training reference data 94 may be embedded, by using a position offset corresponding to the annotated task type (task-specific position embedding 904). For example, the electronic device 200 may encode coordinates of at least one unit on the training reference data 94, the at least one unit being decomposed from the training reference data 94. A task-specific position offset may be used in encoding coordinates. For example, the task-specific position offset may be added to values of at least one coordinate of each unit. Accordingly, by using the task-specific position offset, at least one position embedding representing position information of each unit on the training reference data 94 may be obtained. The at least one position embedding may be combined with a corresponding feature. A feature combined with position embedding may be referred to as a task-specific position embedded feature. Particular operations of the task-specific position embedding 904 may be performed, for example, in a similar manner to those described above with reference to FIGS. 6A and 6B.

With respect to the at least one feature representing the training reference data 94, position information may be embedded for embeddings obtained from the training reference data 94 via feature encoding 902, by using the position offset corresponding to the annotated task type. For example, the electronic device 200 may encode coordinates of a token (e.g., a pixel or a patch) of the reference data 74 on the reference data 74, the token corresponding to each embedding. As described above with reference to FIGS. 6A and 6B, the position offset corresponding to the annotated task type may be used in encoding the coordinates. Accordingly, at least one position embedding representing position information of each token on the reference data 74 may be obtained, by using the position offset corresponding to the annotated task type. The at least one position embedding may be combined with corresponding embedding. Accordingly, the task-specific position embedded at least one feature representing the training reference data 94 may be obtained.

The task-specific position embedded at least one feature representing the training reference data 94 and the at least one feature representing the training prompt 92 having added thereto the task-specific token may be added to the AI model 100. The AI model 100 may provide an output 906, in response to the inputs. The AI model 100 may perform the task indicated by the training prompt 92 on the training reference data 94 or based at least partially on the training reference data 94, according to the task type determined by the task type classifier 102. The output 906 may also be referred to as a product of the AI model 100. In one or more embodiments, the output 906 may indicate a result obtained by processing the product of the AI model 100 to user-understandable representation.

A loss function 908 may be calculated based on the output 906 of the AI model 100 and the ground truths. The loss function 908 may correspond to a difference between the output 906 that the AI model 100 has generated by using the training prompt 92 and the training reference data 94 and the ground truths corresponding to the training prompt 92 and the training reference data 94. The electronic device 200 may update at least one weight matrix of the AI model 100 so as to minimize the loss function 908.

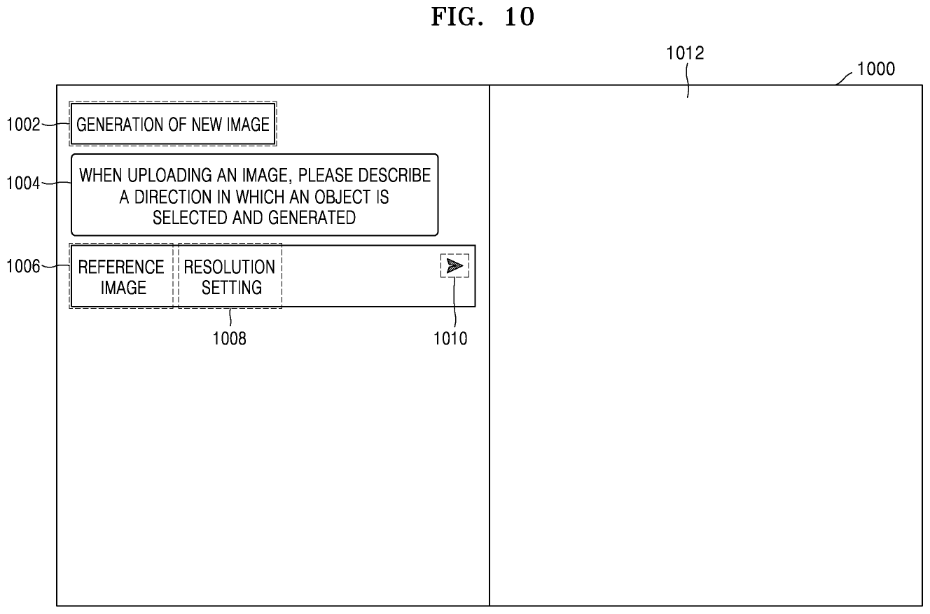

FIG. 10 illustrates a graphic UI (GUI) 1000 provided to the user 10, according to one or more embodiments of the disclosure.

Referring to FIG. 10, the GUI 1000 may be provided to the user 10 via the user interface device 208 of the electronic device 200. The GUI 1000 may display a start screen of an image generation application that uses the AI model 100. In one or more embodiments of FIG. 10, the AI model 100 may be trained to generate an image. For example, the AI model 100 may be implemented in a similar manner to the AI model described with reference to FIG. 7, and may operate in a similar manner thereto. For example, an input prompt indicating a generation condition and a reference image including a reference object may be input from the user 10 to the AI model 100. The AI model 100 may generate a new image, based on the input prompt and the reference image.

The GUI 1000 may include an image generation icon 1002 for receiving an input from the user 10 with respect to an image generation application using the AI model 100. In response to the input from the user 10 with respect to the image generation icon 1002, the electronic device 200 may prepare the AI model 100 to generate a new image. For example, the AI model 100 and the task type classifier 102 may be loaded to the memory 204.

The GUI 1000 may include an input prompt UI 1004 configured to display an image for requesting the user 10 for an input. For example, the input prompt UI 1004 may display a message, such as ‘When uploading an image, please describe a direction in which an object is selected and generated,’ so as to request the user 10 for at least one input. An input prompt in a text form for the input prompt UI 1004 may be input from the user 10. In response to the input being received from the user 10, the input prompt UI 1004 may display visualization of the input prompt from the user 10.

The GUI 1000 may include an image upload icon 1006 for receiving an input from the user 10 with respect to an image upload function. The image upload icon 1006 may include visualized text for describing a function such as ‘image addition’ associated with the image upload icon 1006. In response to an input from the user 10 with respect to the image upload icon 1006, a file select UI in which a file select function supported by the electronic device 200 is visualized may be displayed on the GUI 1000. Via the file select UI, the user 10 may input a reference image to the electronic device 200.

The GUI 1000 may include a resolution setting icon 1008 for receiving an input from the user 10 with respect to a resolution adjustment function for an output of the AI model 100. The resolution setting icon 1008 may include visualization of text describing a function such as ‘resolution setting’ associated with the resolution setting icon 1008. In response to an input from the user 10 with respect to the resolution setting icon 1008, a resolution select UI visualizing a function of selecting one of resolutions of an output which are supported by the AI model 100 may be displayed on the GUI 1000. The user 10 may adjust, via the resolution select UI, a resolution of an output from the image generation application to a desired resolution.

The GUI 1000 may include a model input icon 1010 for receiving an input from the user 10 in response to an input of an input prompt and reference data to the AI model 100. The model input icon 1010 may include a graphical element such as an arrow that visualizes an input. In response to an input from the user 10 with respect to the model input icon 1010, the electronic device 200 may pre-process an input prompt input from the user 10 based on the input prompt UI 1004 and a reference image input from the user 10 based on the image upload icon 1006, and may input the pre-processed inputs to the AI model 100. For example, in response to the input from the user 10 with respect to the model input icon 1010, the electronic device 200 may embed task-specific conditions in the input prompt and the reference image in a similar manner to those described with reference to FIGS. 1, 2, 3, 4, 5A, 5B, 5C, 6A, 6B, and 7. The electronic device 200 may input, to the AI model 100, the pre-processed inputs, e.g., the inputs in which the task-specific conditions are embedded.

The GUI 1000 may include an output UI 1012 for displaying visualization of an output of the AI model 100. The GUI 1000 may correspond an UI visualizing an initial screen of the image generation application, and thus, the output UI 1012 may not display any image.

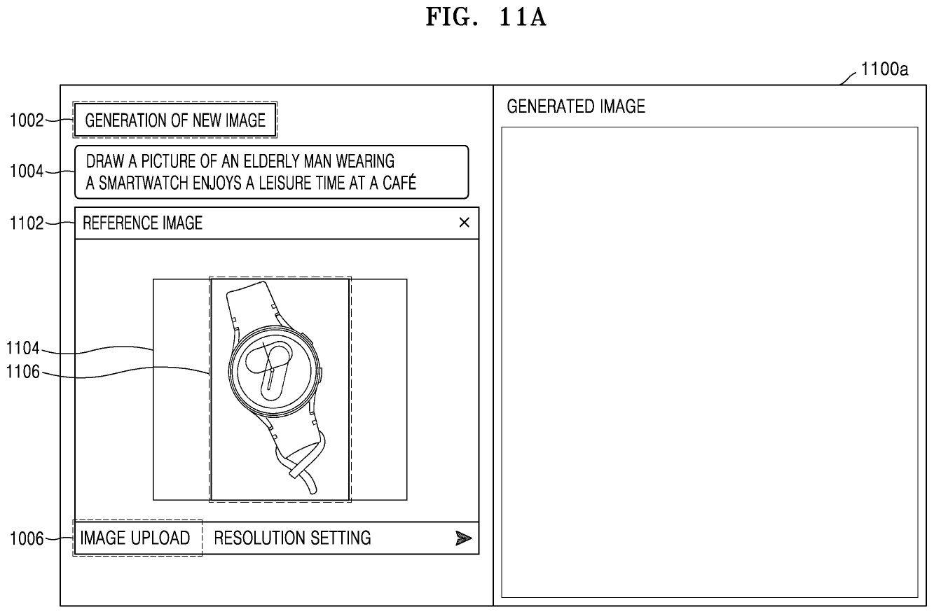

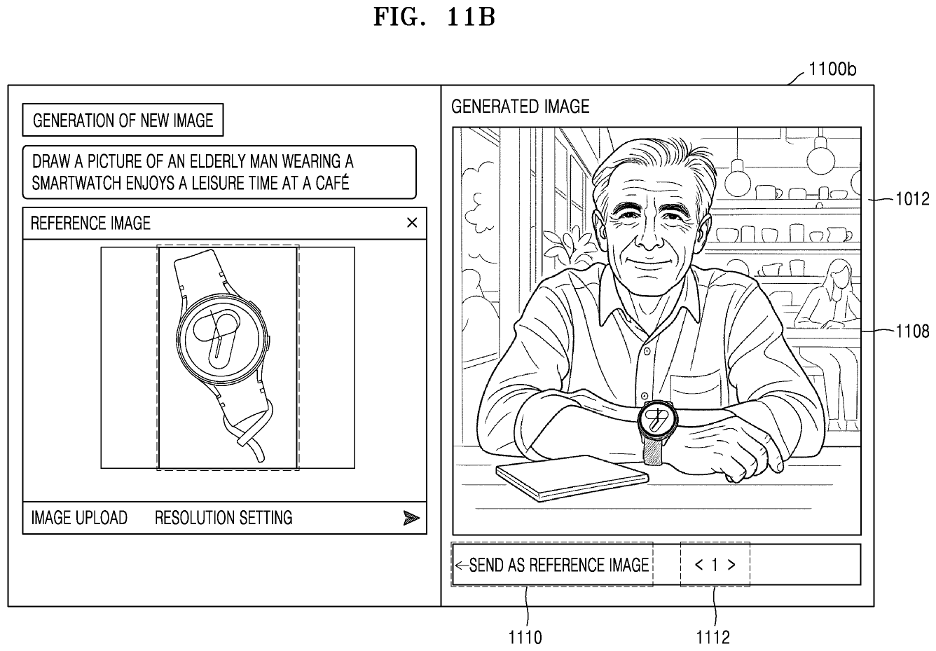

FIG. 11A illustrates a GUI 1100a for displaying an input prompt and reference data input by the user 10, according to one or more embodiments of the disclosure.

Referring to FIG. 11A, the GUI 1100a may be provided to the user 10 via the user interface device 208 of the electronic device 200. The GUI 1100a may display visualizations of an input prompt and a reference image input from the user 10 via the GUI 1000 of FIG. 10. Referring to FIG. 11A, a difference between the GUI 1000 of FIG. 10 and the GUI 1100a of FIG. 11A will be described. Descriptions of the elements of FIG. 11A which are identical or similar to the elements of FIG. 10 may be omitted.

The input prompt UI 1004 of the GUI 1100a may display visualization of an input prompt in a text form input from the user 10. For example, in FIG. 11A, the input prompt UI 1004 may display a text element representing ‘Draw a picture of an elderly man wearing a smartwatch enjoys a leisure time at a café’ which is a text prompt input from the user 10.

The GUI 1100a may include a reference image UI 1102 that displays visualization 1104 of the reference image input from the user 10. The reference image UI 1102 may display the visualization 1104 of the reference image obtained via the input from the user 10 with respect to the image upload icon 1006.

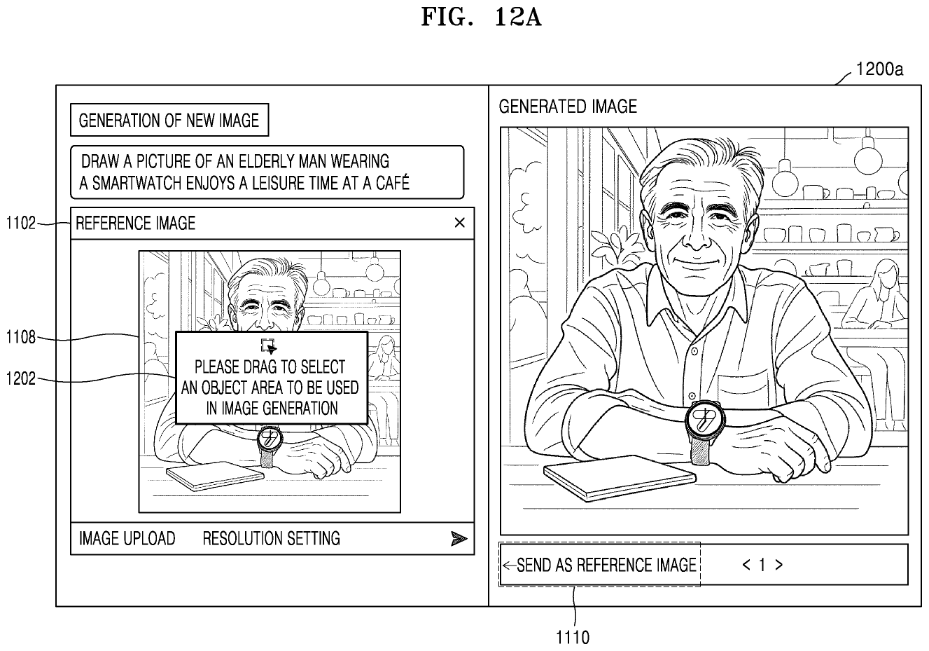

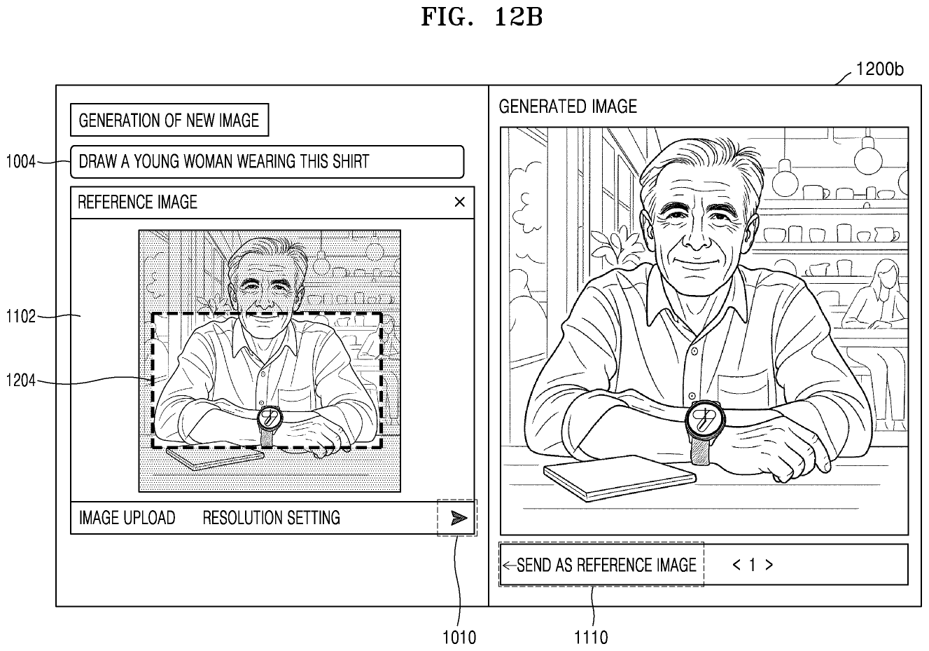

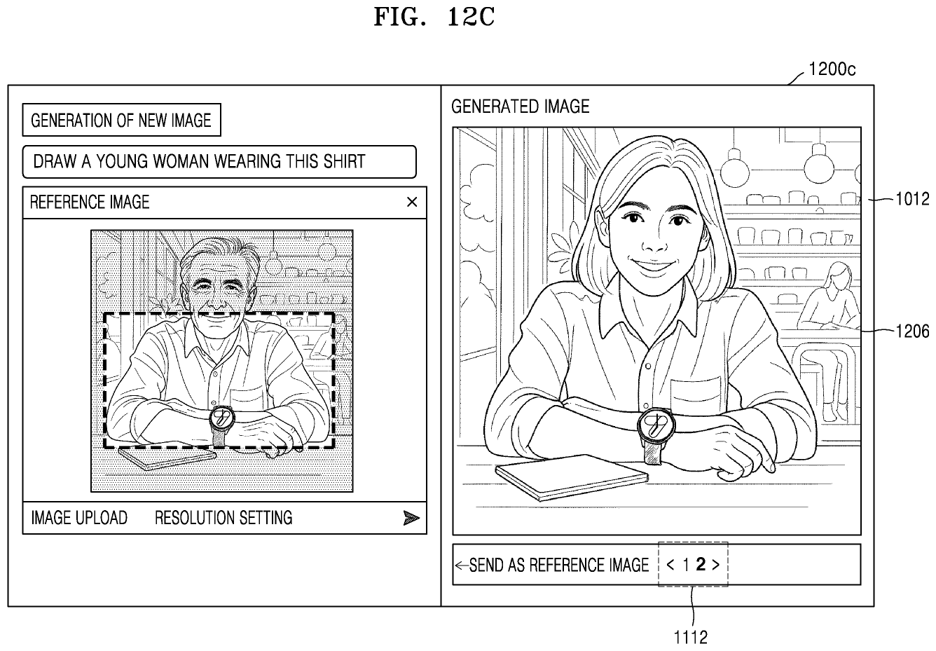

According to one or more embodiments of the disclosure, the electronic device 200 may request the user 10 to select, in the reference image, a part to be used by the AI model 100. Accordingly, the electronic device 200 may obtain, from the user 10, the part of the reference image which is to be used by the AI model 100. An operation of requesting the user 10 to select, in a reference image, a part to be used by the AI model 100 will be described with reference to FIG. 12A.

The GUI 1100a may include an object area element 1106 that displays visualization of the obtained part of the reference image. In the embodiment of FIG. 11A, other parts of the reference image excluding the part selected by the user 10, i.e., the parts not selected by the user 10, may be dimly displayed, compared to the part of the reference image selected by the user 10. Accordingly, the part selected by the user 10 may be emphasized. The user 10 may obtain a feedback from the electronic device 200 with respect to the user-selected part via the object area element 1106.

For example, the user 10 may select a local area including the ‘smartwatch’ in the reference image via the user interface device 208. Other parts (e.g., the background part) in the reference image excluding the local area selected by the user 10 may be relatively dimly displayed on the object area element 1106, compared to the local area selected by the user 10.

FIG. 11B displays a GUI 1100b that displays an image generated based on the input prompt and the reference data of FIG. 11A, according to one or more embodiments of the disclosure.

Referring to FIG. 11A, the GUI 1100b may be provided to the user 10 via the user interface device 208 of the electronic device 200. The GUI 1100b may display an output generated by the AI model 100 in a similar manner to those described with reference to FIGS. 1, 2, 3, 4, 5A, 5B, 5C, 6A, 6B, and 7, based on the input prompt and the reference image input from the user 10 via the GUI 1100a of FIG. 11A. With reference to FIG. 11B, a difference between the GUI 1100a of FIG. 11A and the GUI 1100b of FIG. 11B will be described. Descriptions of the elements of FIG. 11B which are identical or similar to the elements of FIG. 10 or the elements of FIG. 11A may be omitted.

The output UI 1012 of the GUI 1100b may display visualization 1108 of an output image generated by the AI model 100, based on the input prompt displayed in the input prompt UI 1004 of FIG. 11A and the reference image displayed in the reference image UI 1102. The output image generated by the AI model 100 may show an elderly man sitting in a café wears an object ‘smartwatch’ emphasized by the object area element 1106. The user 10 may visually recognize a product via the visualization 1108 of the output image which is displayed in the output UI 1012.

The GUI 1100b may include a reference image transmission icon 1110. The reference image transmission icon 1110 may include visualized text or a graphical element such as ‘Transmit as a reference’ which indicates activation of a function of using the output image currently displayed on the output UI 1012 as a reference image of a subsequent image generation operation. In response to an input by the user 10 with respect to the reference image transmission icon 1110, data of the output image currently displayed on the output UI 1012 (e.g., output image data corresponding to the visualization 1108 of the output image) may be provided subsequently as a reference image to the AI model 100. One or more embodiments in which an output image currently displayed on the output UI 1012 is used as subsequent reference data for the AI model 100 will be described with reference to FIGS. 12A. 12B, and 12C.

The GUI 1100b may display an output select UI 1112 that displays at least one index value for at least one output image generated by the AI model 100 so far and stored in the electronic device 200. The output select UI 1112 may display visualization of indices of images generated so far by the AI model 100. The user 10 may view again, via the output select UI 1112, an output image previously generated. In response to an input by the user 10 with respect to a particular index among the indices displayed on the output select UI 1112, visualization of an output image corresponding to the particular index may be displayed on the output UI 1012.

FIG. 12A illustrates a GUI 1200a that displays a generated image of FIG. 11B as reference data, according to one or more embodiments of the disclosure.

Referring to FIG. 12A, the GUI 1200a may be provided to the user 10 via the user interface device 208 of the electronic device 200. The GUI 1200a may display an operation in which the output image data corresponding to the visualization 1108 of the output image and displayed on the output UI 1012 of FIG. 11B is input as a reference image of the AI model 100. With reference to FIG. 12A, the GUI 1100b of FIG. 11B and the GUI 1200a of FIG. 12A will be described. Descriptions of the elements of FIG. 12A which are identical or similar to the elements of FIGS. 10, 11A, and 11B may be omitted.

In response to an input by the user 10 with respect to the reference image transmission icon 1110, the electronic device 200 may use, as the reference image of the AI model 100, an output image displayed on the output UI 1012 at the time of the input by the user 10 with respect to the reference image transmission icon 1110. Accordingly, the visualization 1108 of the output image and displayed on the output UI 1012 in FIG. 11B may be displayed on the reference image UI 1102 in FIG. 12A.

The GUI 1200a may include an object select UI 1202. The object select UI 1202 may display visualization of an area select function for selecting an area on a reference image. For example, the object select UI 1202 may include text such as ‘Please drag to select an object area to be used in image generation’ for requesting the user 10 to select an area including a particular object in the visualization 1108 of the output image. With respect to the object select UI 1202, the user 10 may select the area including the particular object in the visualization 1108 of the output image. For example, the user 10 may select the area including the particular object via a drag operation, but the disclosure is not limited thereto. For example, the electronic device 200 may detect at least one object included in a reference image, and may request the user 10 to select any one of detected objects. For example, the electronic device 200 may request the user 10 to select a particular object on the reference image, and may obtain, from the user 10, a select input with respect to the particular object. The electronic device 200 may detect at least one object included in a reference image, and may select an object corresponding to a select input by the user 10.

FIG. 12B illustrates a GUI 1200b that displays the area on the reference image which is selected by the user 10 in FIG. 12A, according to one or more embodiments of the disclosure.

Referring to FIG. 12B, the GUI 1200b may be provided to the user 10 via the user interface device 208 of the electronic device 200. According to one or more embodiments of the disclosure, the user 10 attempts to generate a subsequent output by using an object included in a part generated by the AI model 100. The GUI 1200b may include an object area element 1204 that displays an area on a reference image which is selected by the user 10 via the GUI 1200a of FIG. 12A. With reference to FIG. 12B, the GUI 1200a of FIG. 12A and the GUI 1200b of FIG. 12B will be described. Descriptions of the elements of FIG. 12B which are identical or similar to the elements of FIGS. 10, 11A, 11B, and 12A may be omitted.

The object area element 1204 included in the reference image UI 1102 may display visualization of a part of an objected reference image. In the embodiment of FIG. 12B, other parts of the reference image excluding the part selected by the user 10, i.e., the parts not selected by the user 10, may be dimly displayed, compared to the part of the reference image selected by the user 10. Accordingly, the part selected by the user 10 may be emphasized. The user 10 may obtain a feedback from the electronic device 200 with respect to the user-selected part via the object area element 1204.

For example, the user 10 may select a local area including the ‘shirt’ in the reference image via the user interface device 208. Other parts (e.g., the background part) in the reference image excluding the local area selected by the user 10 may be relatively dimly displayed on the object area element 1204, compared to the local area selected by the user 10.

The input prompt UI 1004 of the GUI 1200b may display visualization of an input prompt in a text form newly input from the user 10. For example, in FIG. 12B, the input prompt UI 1004 may display a text element representing ‘Draw a young woman wearing this shirt’ which is a text prompt input from the user 10. In response to an input by the user 10 with respect to the model input icon 1010, the reference image displayed in the reference image UI 1102 and the input prompt displayed in the input prompt UI 1004 may be input to the AI model 100.

FIG. 12C illustrates a GUI 1200c that displays an image generated based on an input prompt and reference data of FIG. 12B, according to one or more embodiments of the disclosure.

Referring to FIG. 12C, the GUI 1200c may be provided to the user 10 via the user interface device 208 of the electronic device 200. The GUI 1200c may display an output generated by the AI model 100 in a similar manner to those described with reference to FIGS. 1, 2, 3, 4, 5A, 5B, 5C, 6A, 6B, and 7, based on the input prompt and the reference image displayed on the GUI 1200b of FIG. 12B. With reference to FIG. 12C, a difference between the GUI 1200b of FIG. 12B and the GUI 1200c of FIG. 12C will be described. Descriptions of the elements of FIG. 12C which are identical or similar to the elements of FIGS. 10, 11A, 11B, 12A, and 12B may be omitted.

The output UI 1012 of the GUI 1200c may display visualization 1206 of an output image which is generated by the AI model 100 based on the input prompt displayed in the input prompt UI 1004 and the reference image displayed in the reference image UI 1102 of FIG. 12B. The output image generated by the AI model 100 may show a woman sitting in a café wears an object ‘shirt’ emphasized by the object area element 1204. The user 10 may visually recognize a product via visualization 1206 of the output image which is displayed in the output UI 1012. A visual element representing an index ‘2’ of an output image corresponding to the visualization 1206 of the output image may be displayed in the output select UI 1112.

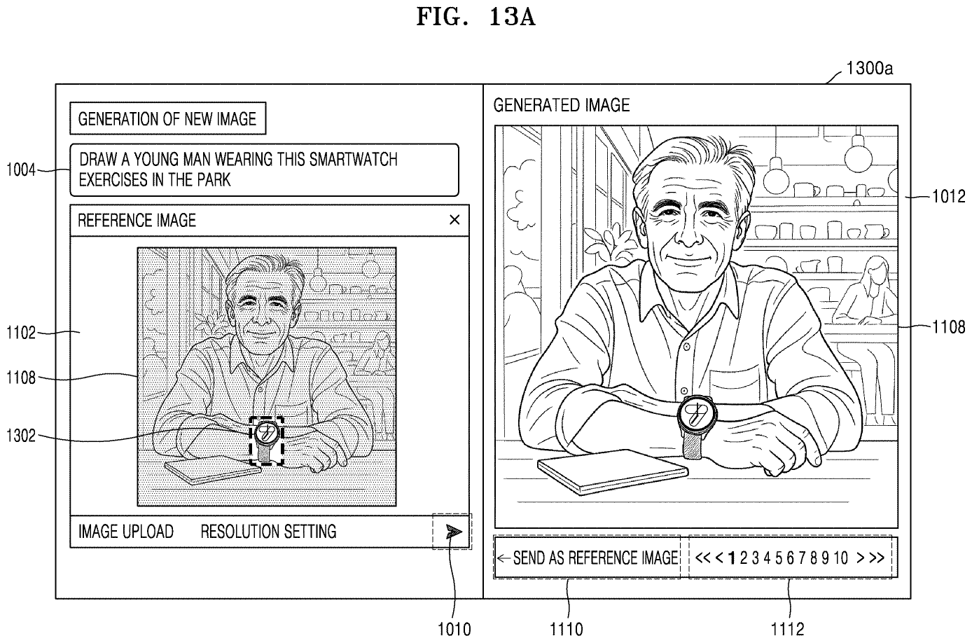

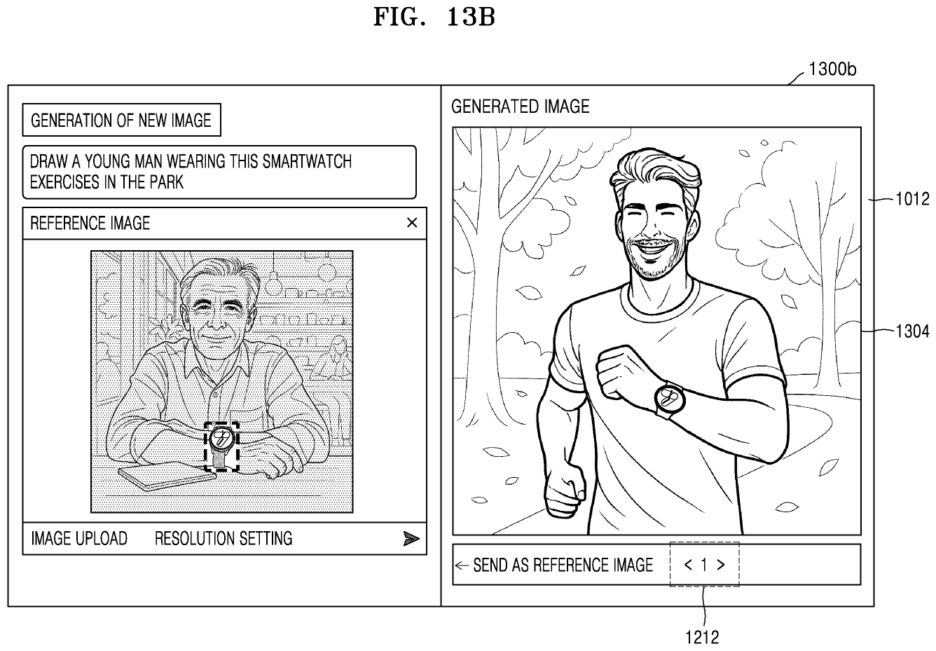

FIG. 13A illustrates a GUI that displays a generated image of FIG. 11B as reference data, according to one or more embodiments of the disclosure.

Referring to FIG. 13A, a GUI 1300a may be provided to the user 10 via the user interface device 208 of the electronic device 200. According to one or more embodiments of the disclosure, the user 10 may use again a pre-generated output image as a reference image. The user 10 may select again a reference object used in generating the output image. The GUI 1300a may re-load an output image displayed on the GUI 1100b of FIG. 11B, and may display an operation of using the re-loaded output image as a reference image. With reference to FIG. 13A, a difference between the GUI 1100b of FIG. 11B and the GUI 1300a of FIG. 13A will be described. Descriptions of the elements of FIG. 13A which are identical or similar to the elements of FIGS. 10, 11A, 11B, 12A, 12B, and 12C may be omitted.

In the GUI 1300a of FIG. 13A, the output select UI 1112 may visually display indices of 10 pre-generated outputs. In response to an input to an index ‘1’ from the user 10, the output UI 1012 may display visualization of an output image corresponding to the index ‘1’. For example, the output image corresponding to the index ‘1’ may be an output image displayed to the user 10 in FIG. 11B, and thus, the visualization 1108 of the output image displayed in FIG. 11B may be displayed again on the output UI 1012.

The user 10 may recognize the visualization 1108 of the output image displayed on the output UI 1012. In order to use the output image displayed on the output UI 1012 as a reference image, the user 10 may provide an input with respect to the reference image transmission icon 1110 to the electronic device 200. In response to the input by the user 10, the visualization 1108 of the output image may be displayed on the reference image UI 1102.

The user 10 may input a new input prompt to the electronic device 200. The input prompt UI 1004 of the GUI 1300a may display visualization of the input prompt in a text form newly input from the user 10. For example, referring to FIG. 13B, the input prompt UI 1004 may display a text element representing ‘Draw a young man wearing this smartwatch exercises in the park’ which is a text prompt newly input from the user 10.

In order to indicate an object associated with the input prompt in the reference image displayed on the reference image UI 1102, the user 10 may select an area of the reference image. For example, in a similar manner to those described with reference to FIG. 12B, the user 10 may select the area of the reference image. An object area element 1302 included in the reference image UI 1102 may display visualization of the area of the reference image which is selected by the user 10. In the embodiment of FIG. 13A, other parts of the reference image excluding the part selected by the user 10, i.e., the parts not selected by the user 10, may be dimly displayed, compared to the part of the reference image selected by the user 10. Accordingly, the part selected by the user 10 may be emphasized. The user 10 may obtain a feedback from the electronic device 200 with respect to the user-selected part via the object area element 1302.

For example, the user 10 may select a local area including the ‘smartwatch’ in the reference image via the user interface device 208. Other parts (e.g., the background part) in the reference image excluding the local area selected by the user 10 may be relatively dimly displayed on the object area element 1302, compared to the local area selected by the user 10. In response to an input by the user 10 with respect to the model input icon 1010, the reference image displayed in the reference image UI 1102 and the input prompt displayed in the input prompt UI 1004 may be input to the AI model 100.

FIG. 13B illustrates a GUI 1300b that displays an image generated based on an input prompt and reference data of FIG. 13A, according to one or more embodiments of the disclosure.

Referring to FIG. 13B, the GUI 1300b may be provided to the user 10 via the user interface device 208 of the electronic device 200. The GUI 1300b may display an output generated by the AI model 100 in a similar manner to those described with reference to FIGS. 1, 2, 3, 4, 5A, 5B, 5C, 6A, 6B, and 7, based on the input prompt and the reference image displayed on the GUI 1300a of FIG. 13A. With reference to FIG. 13B, a difference between the GUI 1300a of FIG. 13A and the GUI 1300b of FIG. 13B will be described. Descriptions of the elements of FIG. 13B which are identical or similar to the elements of FIGS. 10, 11A, 11B, 12A, 12B, 12C, and 13A may be omitted.

The output UI 1012 of the GUI 1300b may display visualization 1304 of an output image which is generated by the AI model 100 based on the input prompt displayed in the input prompt UI 1004 and the reference image displayed in the reference image UI 1102 of FIG. 12B. The output image generated by the AI model 100 may show a young man jogging in the part wears an object ‘smartwatch’ emphasized by the object area element 1302. The user 10 may visually recognize a product via the visualization 1304 of the output image which is displayed in the output UI 1012.

According to one or more embodiments of the disclosure, based on a particular condition being satisfied, indices displayed in an output select UI 1212 may be initialized. For example, the particular condition may include reception of a user input with respect to the image generation icon 1002, an input by the user 10 with respect to re-usage of a pre-used image, or an excess of a threshold number of indices displayed in the output select UI 1212, but the disclosure is not limited thereto. In FIG. 13B, the indices displayed in the output select UI 1212 may be initialized. Accordingly, only a visual element corresponding to an index ‘1’ of the output image corresponding to the visualization 1304 of the output image may be displayed in the output select UI 1212.

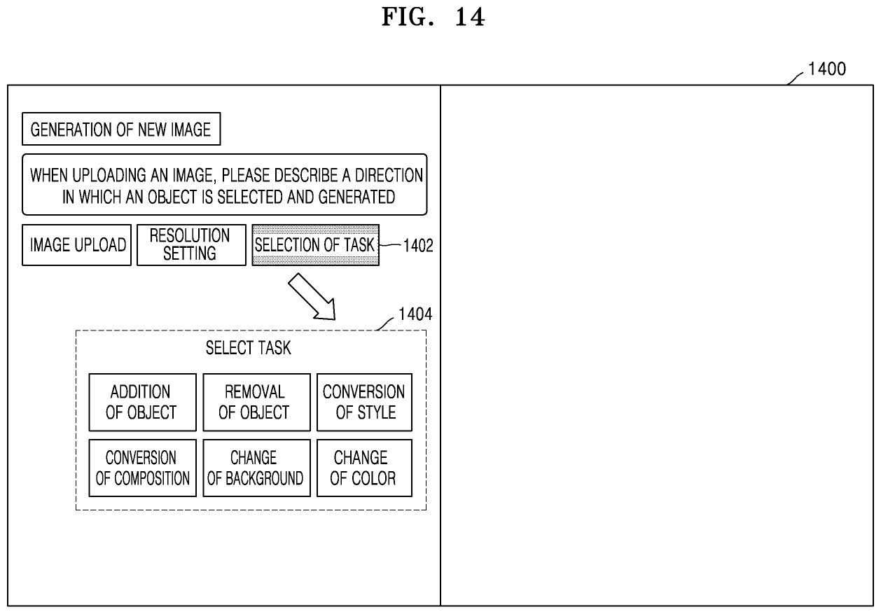

FIG. 14 illustrates a GUI 1400 that displays a task select function, according to one or more embodiments of the disclosure.

Referring to FIG. 14, the GUI 1400 may be provided to the user 10 via the user interface device 208 of the electronic device 200. The GUI 1400 may display a start screen of an image generation application that uses the AI model 100. For example, the GUI 1400 may include at least some of elements included in the GUI 1000 shown in FIG. 10. In one or more embodiments, the GUI 1400 may include a task select icon 1402. In response to an input by the user 10 with respect to the task select icon 1402, a task select UI 1404 may be displayed on the GUI 1400. With reference to FIG. 14, a difference between the GUI 1000 of FIG. 10 and the GUI 1400 of FIG. 14 will be described. Descriptions of the elements of FIG. 14 which are identical or similar to the elements of FIG. 10 may be omitted.

The GUI 1400 may include the task select icon 1402 for receiving an input by the user 10 with respect to a task select function. The task select icon 1402 may include visualized text such as ‘Selection of task’ which describes the task select function. In response to an input by the user 10 with respect to the task select icon 1402, the task select UI 1404 that visualizes a plurality of tasks that may be performed by the AI model 100 may be displayed on the GUI 1400. According to one or more embodiments of the disclosure, the task select UI 1404 may be displayed in the pop-up form or the modal form, but a display form of the task select UI 1404 is not limited thereto.

The task select UI 1404 may include a plurality of icons respectively indicating the plurality of tasks that may be performed by the AI model 100. For example, the task select UI 1404 may display the plurality of icons, such as ‘addition of object,’ ‘removal of object,’ ‘conversion of style,’ ‘conversion of composition,’ ‘change of background,’ and ‘change of color,’ which include a plurality of texts respectively corresponding to the plurality of tasks that may be performed by the AI model 100.

In response to an input by the user 10 with respect to a particular icon displayed in the task select UI 1404, task information indicating a task corresponding to the particular icon may be generated. The task information may be provided to the task type classifier 102 of the electronic device 200. The task type classifier 102 may determine at least one task type corresponding to an input prompt based on the task information, in a similar manner to that described with reference to FIG. 5B. Based on the at least one task type determined based on the task information, an output based on the input prompt and the reference data may be generated from the AI model 100.

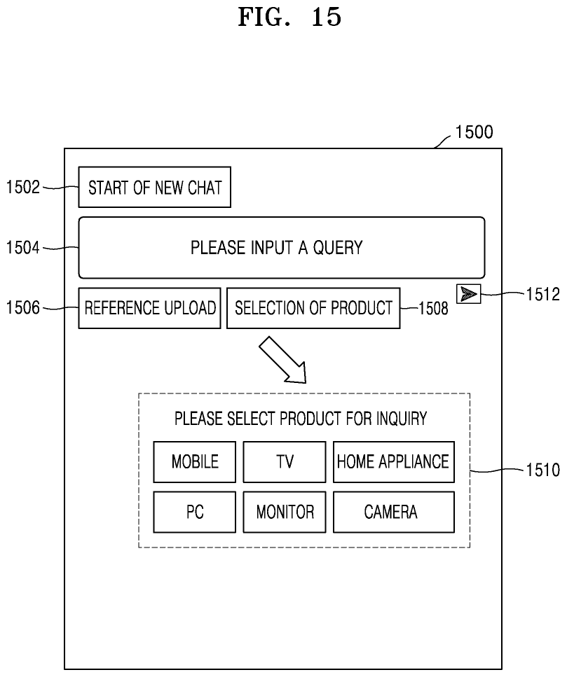

FIG. 15 illustrates a GUI 1500 that displays a chatbot application, according to one or more embodiments of the disclosure.

Referring to FIG. 15, the GUI 1500 may be provided to the user 10 via the user interface device 208 of the electronic device 200. The GUI 1500 may display a start screen of the chatbot application that uses the AI model 100. In the embodiment of FIG. 15, the chatbot application may use the AI model 100 based on a large language model (LLM). The AI model 100 may be trained to receive an input prompt and reference data including a query from the user 10 and to generate a text response to the query, based on the input prompt and the reference data. For example, an input prompt including a query about a product associated with reference data and the reference data including information associated with the product may be input from the user 10 to the AI model 100. The AI model 100 may generate a response to the query, based on the input prompt and the reference data.

The GUI 1500 may include a chat start icon 1502 for receiving an input from the user 10 with respect to the chatbot application that uses the AI model 100. The chat start icon 1502 may include visualized text such as ‘start new chat’ which describes a function associated with a start or initialization of the chatbot application. In response to an input by the user 10 with respect to the chat start icon 1502, the electronic device 200 may prepare the AI model 100 to generate a response to a query to be input from the user 10 in the near future. For example, the AI model 100 and the task type classifier 102 may be loaded to the memory 204.

The GUI 1500 may include an input prompt UI 1504 that displays a message for requesting the user 10 for an input. For example, the input prompt UI 1504 may display a message requesting the user 10 for a text input including a query such as ‘Please input a query’. An input prompt in a text form may be input from the user 10 for the input prompt UI 1504. In response to the input by the user 10 being received, the input prompt UI 1504 may display visualization of the input prompt from the user 10.

The GUI 1500 may include a reference upload icon 1506 for receiving an input by the user 10 with respect to a reference upload function. The reference upload icon 1506 may include visualized text such as ‘reference upload’ which describes a function associated with the reference upload icon 1506. In response to an input by the user 10 with respect to the reference upload icon 1506, a file select UI that visualizes a function of selecting files supportable by the electronic device 200 may be displayed on the GUI 1500. Via the file select UI, the user 10 may input a reference material to the electronic device 200. The reference material input from the user 10 may be used as reference data by the electronic device 200.

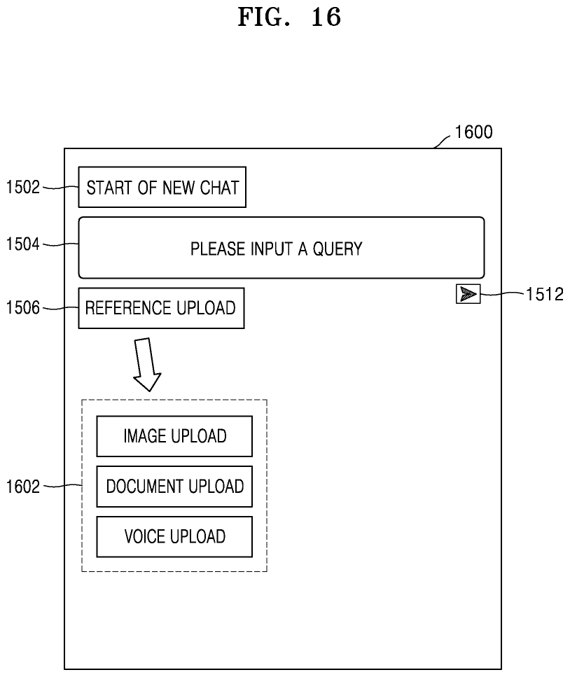

According to one or more embodiments of the disclosure, in response to the input by the user 10 with respect to the reference upload icon 1506, a UI that visualizes a function of selecting a modality of a reference may be displayed. The UI that visualizes a function of selecting a modality of a reference will be described with reference to FIG. 16.

The GUI 1500 may include a domain select icon 1508 for receiving an input from the user 10 with respect to a domain select function. The domain select icon 1508 may include visualized text such as ‘selection of product’ which describes a function of selecting any one of domains in which the AI model 100 is trained (in the embodiment of FIG. 15, electronic products in which the AI model 100 is trained). In response to an input by the user 10 with respect to the domain select icon 1508, a domain select UI 1510 that visualizes a plurality of domains that may be performed by the AI model 100 may be displayed on the GUI 1500. According to one or more embodiments of the disclosure, the domain select UI 1510 may be displayed in the pop-up form or the modal form, but a display form of the domain select UI 1510 is not limited thereto.

The domain select UI 1510 may include a plurality of icons respectively indicating the plurality of domains that may be performed by the AI model 100. For example, the domain select UI 1510 may display the plurality of icons, such as ‘mobile,’ ‘TV,’ ‘home appliance,’ ‘PC,’ ‘monitor,’ and ‘camera,’ which include a plurality of texts respectively corresponding to the plurality of domains that may be performed by the AI model 100.

In response to an input by the user 10 with respect to a particular icon displayed in the domain select UI 1510, domain information indicating a domain corresponding to the particular icon may be generated. The domain information may be provided to the task type classifier 102 of the electronic device 200. The domain information may inform the task type classifier 102 of a domain to which a task type corresponding to an input prompt belongs. The task type classifier 102 may identify at least one domain corresponding to the input prompt, based on the domain information, in a similar manner to those described with reference to FIGS. 5A, 5B, and 5C. The task type classifier 102 may determine at least one task type corresponding to the input prompt, based on the identified domain. Based on the at least one task type determined based on the domain information, an output based on the input prompt and the reference data may be generated from the AI model 100.

The GUI 1500 may include a model input icon 1512 for receiving an input from the user 10 with respect to an input of an input prompt and reference data to the AI model 100. The model input icon 1512 may include a graphical element such as an arrow that visualizes an input. In response to an input from the user 10 with respect to the model input icon 1512, the electronic device 200 may pre-process an input prompt input from the user 10 based on the input prompt UI 1504 and reference data input from the user 10 based on the reference upload icon 1506, and may input the pre-processed inputs to the AI model 100. For example, in response to the input from the user 10 with respect to the model input icon 1512, the electronic device 200 may embed task-specific conditions in the input prompt and the reference image in a similar manner to those described with reference to FIGS. 1, 2, 3, 4, 5A, 5B, 50, 6A, and 6B. The electronic device 200 may input, to the AI model 100, the pre-processed inputs, e.g., the inputs in which the task-specific conditions are embedded.

In one or more embodiments, the GUI 1500 may include an output UI for displaying visualization of an output of the AI model 100. The GUI 1500 may correspond an UI visualizing an initial screen of the image generation application, and thus, the output UI may not display current response text.

According to one or more embodiments of the disclosure, in the embodiment of FIG. 15, the chatbot application using the AI model 100 may provide responses to queries from the user 10 with respect to various products. Via the GUI 1500, the user 10 may input, to the electronic device 200, an input prompt including a query about a problem or a defect of a particular product with a reference material representing a state of the product. For example, the reference material representing the state of the product may be various types of data, such as error code shown on a display apparatus of the product, a picture showing a damaged product, debug log provided from the product, text including an error message, or an incorrect audio signal output from the product.

The electronic device 200 may pre-process the input prompt and the reference material in a similar manner to those described with reference to FIGS. 1, 2, 3, 4, 5A, 5B, 5C, 6A, and 6B, and may input the pre-processed input prompt and the pre-processed reference material to the AI model 100. The AI model 100 may generate a response to the query, based on the state of the produced represented in the reference material. The response generated by the AI model 100 may be provided to the user 10. For example, the response generated by the AI model 100 may include a reason of the problem or the defect of the produced which is included in the query from the user 10, and a means for solving the reason.

According to one or more embodiments of the disclosure, the task type classifier 102 may identify a domain of the AI model 100 corresponding to the input prompt, based on the input prompt including the query from the user 10 or the reference material representing the state of the product. For example, the task type classifier 102 may identify the product (or a product family) indicated by the input prompt or the reference material from the user 10, by using the object detector 504, in a similar manner to that described with reference to FIG. 5C. In one or more embodiments, the task type classifier 102 may identify the domain of the AI model 100 corresponding to the input prompt, based on domain information. The task type classifier 102 may determine the domain corresponding to the identified product or product family. The task type classifier 102 may determine at least one task type corresponding to the input prompt, based on the determined domain.

FIG. 16 illustrates a GUI 1600 that displays an element for selecting a type of reference data, according to one or more embodiments of the disclosure.

Referring to FIG. 16, the GUI 1600 may be provided to the user 10 via the user interface device 208 of the electronic device 200. In the embodiment of FIG. 16, a chatbot application may use the AI model 100 based on an LLM. The AI model 100 may be trained to receive an input prompt and reference data including a query from the user 10 and to generate a text response to the query, based on the input prompt and the reference data. For example, an input prompt including a query about a product associated with reference data and the reference data including information associated with the product may be input from the user 10 to the AI model 100. The AI model 100 may generate a response to the query, based on the input prompt and the reference data.

The GUI 1600 may display a start screen of the chatbot application that uses the AI model 100. The GUI 1600 may include at least some of elements included in the GUI 1500 shown in FIG. 15. For example, the GUI 1600 may include the chat start icon 1502, the input prompt UI 1504, the reference upload icon 1506, and the model input icon 1512 of FIG. 15. With reference to FIG. 16, a difference between the GUI 1500 of FIG. 15 and the GUI 1600 of FIG. 16 will be described. Descriptions of the elements of FIG. 16 which are identical or similar to the elements of FIG. 10 may be omitted.

The user 10 may input a query to the chatbot application shown in FIG. 16 and select information of various modalities as a reference or analysis target, and may input the selected information as a reference material. The electronic device 200 may identify a modality of reference data, and may determine, based on the identified modality of the reference data, a method of generating position embedding, in a similar manner to that described with reference to FIG. 6B. According to one or more embodiments of the disclosure, the electronic device 200 may analyze the reference data, and may identify the modality of the reference data, based on the analysis.

According to one or more embodiments of the disclosure, the electronic device 200 may display a reference upload UI 1602 on the user interface device 208 so as to obtain information about a modality from the user 10. For example, in response to an input by the user 10 with respect to the reference upload icon 1506, the reference upload UI 1602 may be displayed on the GUI 1600. The reference upload UI 1602 may display visualization of a function of selecting a modality of a reference. For example, the reference upload UI 1602 may include a plurality of icons, such as the ‘image upload’ icon, the ‘document upload’ icon, or the ‘voice upload’ icon, which respectively correspond to a plurality of modalities supported by the AI model 100. In response to an input by the user 10 with respect to each icon in the reference upload UI 1602, a UI that visualizes a function of inputting data of a corresponding modality may be provided to the user 10. According to one or more embodiments of the disclosure, the reference upload UI 1602 may be displayed in the pop-up form or the modal form, but a display form of the reference upload UI 1602 is not limited thereto.

The electronic device 200 may obtain information about a modality of reference data, based on an input by the user 10 with respect to icons corresponding to different modalities include in the reference upload UI 1602. The information about the modality of the reference data, the electronic device 200 may identify the modality of the reference data. Based on the identified modality of the reference data, the electronic device 200 may determine a method of generating position embedding, in a similar manner to that described with reference to FIG. 6B. Accordingly, position embedding specified for each modality of the reference data may be generated, and thus, an effect of embedding position information may be enhanced. As a result, the chatbot application shown in FIG. 16 may perform all of a text-based operation, a voice-based operation, and an image-based operation. For example, according to modalities of reference data, the chatbot application shown in FIG. 16 may perform different functions.

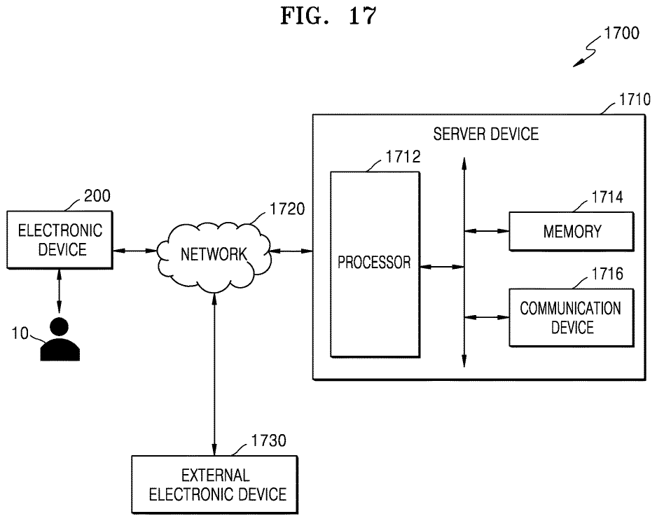

FIG. 17 illustrates a block diagram of a system 1700 according to one or more embodiments of the disclosure.

Referring to FIG. 17, the system 1700 may include the electronic device 200 of FIG. 2, a server device 1710, an external electronic device 1730, and a network 1720. FIG. 17 illustrates only one or more elements for describing functions and/or operations of the system 1700, but elements included in the system 1700 are not limited to those shown in FIG. 17. A configuration of the system 1700 shown in FIG. 17 is merely an example, and an example of the system 1700 which performs one or more embodiments of the disclosure is not limited to the configuration of the system 1700. According to one or more embodiments of the disclosure, one or more configurations shown in FIG. 17 may be deleted or modified in the system 1700, and In one or more embodiments, a configuration not shown in FIG. 17 may be added to the system 1700.

The electronic device 200 may receive at least one input via the user interface device 208 from the user 10. The electronic device 200 may provide one or more outputs to the user 10 via the user interface device 208. The electronic device 200 may receive data from the server device 1710 and the external electronic device 1730 or may transmit data to the server device 1710 and the external electronic device 1730, via the communication device 206 through the network 1720.

The server device 1710 may include a processor 1712, memory 1714, and a communication device 1716. The processor 1712 may be an element for controlling a series of processes to allow the server device 1710 to operate according to embodiments to be described below. FIG. 17 illustrates the processor 1712 as one element, but the disclosure is not limited thereto. For example, the processor 1712 may include one or more processors. The one or more processors included in the processor 1712 may each be circuitry such as a SoC, an IC, or the like. The one or more processors included in the processor 1712 may each be a general-purpose processor such as a CPU, a MPU, an AP, a DSP, or the like, a graphics-dedicated processor such as a GPU, a VPU or the like, an AI-dedicated processor such as a NPU, or a communication-dedicated processor such as a CP. When the one or more processors included in the processor 1712 is each an AI-dedicated processor, the corresponding AI-dedicated processor may be designed in a hardware structure specialized for processing a particular AI model.

The processor 1712 may include various types of processing circuitry and/or a plurality of processors. In some embodiments of the disclosure, a ‘processor’ may include at least one processor, and In one or more embodiments, may include various types of processing circuitry. The one or more processors individually and/or collectively may be configured to perform various functions described in the disclosure in a distributed manner. As used herein, a ‘processor,’ ‘at least one processor,’ and ‘one or more processors’ may be configured to perform various functions. However, these terms may cover, without limitation, a situation where one processor performs some functions and other processor(s) perform other functions, and a situation where a single processor may perform all functions. In addition, the at least one processor may include a combination of processors that perform the disclosed various functions in a distributed manner. The at least one processor individually or collectively may execute program instructions to accomplish or perform various functions.

The processor 1712 may control all operations of the server device 1710. In one or more embodiments, the processor 1712 may control the server device 1710 to perform at least some of the operations according to one or more embodiments of the disclosure described below. For example, the processor 1712 may transmit and/or receive a signal to and/or from an external source via the communication device 1716. The processor 1712 may write data to the memory 1714 and may read data written to the memory 1714. For example, the processor 1712 may execute one or more instructions of a program stored in the memory 1714 so as to process data according to a predefined operation rule or an AI model. Accordingly, the processor 1712 may perform operations to be described in embodiments of the disclosure. In the disclosure, operations described as being performed by the server device 1710 or the elements 1712, 1714, and 1716 included in the server device 1710 may be understood as being performed by the processor 1712 unless otherwise described.

The memory 1714 may store instructions, data structures, and/or program codes which are readable by the processor 1712. The memory 1714 may store (or load) a program or at least one instruction for performing operations according to the following embodiments of the disclosure. The memory 1714 may provide the stored data to the processor 1712, in response to a request from the processor 1712. For example, the memory 1714 may store data such as basic programs, application programs, and configuration information for the operation of the server device 1710. In one or more embodiments of the disclosure, the memory 1714 may store instructions that, when executed by the processor 1712 individually or collectively, cause the server device 1710 to perform at least some of the operations of the server device 1710 to be described below. For example, the processor 1712 may execute one or more instructions or codes stored in the memory 1714 to perform at least some of the operations of the server device 1710 described in the disclosure.

The memory 1714 may include at least one of a flash memory, a hard disk, a multimedia card micro-type memory, or a card-type memory (or storage medium). For example, the memory 1714 may include non-volatile memory including at least one of ROM, EEPROM, PROM, magnetic memory, magnetic disk, or optical disk, and/or volatile memory such as DRAM and/or SRAM.

The communication device 1716 may be an element for transmitting/receiving signals (e.g., control commands, data, etc.) to/from an external device by wire or wirelessly. The communication device 1716 may be implemented to include a communication chipset that supports various communication protocols. The communication device 1716 may receive a signal from an external source and may provide the signal to the processor 1712. The communication device 1716 may transmit a signal provided from the processor 1712 to an external source. The server device 1710 may communicate with external devices via the communication device 1716. For example, the server device 1710 may communicate with the electronic device 200 and the external electronic device 1730 via the communication device 1716 through the network 1720.

Some operations among a plurality of operations to be performed by the electronic device 200 of FIG. 2, which are described with reference to FIGS. 1, 2, 3, 4, 5A, 5B, 5C, 6A, 6B, 7, 8, 9, 10, 11A, 11B, 12A, 12B, 12C, 13A, 13B, 14, 15, and 16, may be distributed to the server device 1710. The server device 1710 may perform any combination of one or more operations to be performed by the electronic device 200 of FIG. 2 which are described with reference to FIGS. 1, 2, 3, 4, 5A, 5B, 5C, 6A, 6B, 7, 8, 9, 10, 11A, 11B, 12A, 12B, 12C, 13A, 13B, 14, 15, and 16.

For example, the memory 1714 may store one or more instructions, data structures, and/or program codes for executing the AI model 100 and/or the task type classifier 102 of FIG. 1. For example, the server device 1710 may additionally include a storage device (example: hard disk or non-volatile memory device) configured to store the one or more instructions, the data structures, and/or the program codes for executing the AI model 100 and/or the task type classifier 102. The one or more instructions, the data structures, and/or the program codes which are stored in the storage device so as to execute the AI model 100 and/or the task type classifier 102 may be loaded to the memory 1714. The AI model 100 and/or the task type classifier 102 which are loaded to the memory 1714 may be executed by the processor 1712. When the AI model 100 and/or the task type classifier 102 are executed by the processor 1712, the server device 1710 may perform any combination of one or more operations to be performed by the electronic device 200 of FIG. 2 which are described with reference to FIGS. 1, 2, 3, 4, 5A, 5B, 5C, 6A, 6B, 7, 8, 9, 10, 11A, 11B, 12A, 12B, 12C, 13A, 13B, 14, 15, and 16.

According to one or more embodiments of the disclosure, the task type classifier 102 may be executed (or operate) in the electronic device 200, and the AI model 100 may be executed in the server device 1710. The electronic device 200 may obtain an input prompt and reference data from the user 10, and may determine at least one task type corresponding to the input prompt. The electronic device 200 may transmit, to the server device 1710, task type information indicating the determined at least one task type, the input prompt, and the reference data with a request for execution of the AI model 100. The server device 1710 may receive, from the electronic device 200, the information indicating the determined at least one task type, the input prompt, and the reference data with the request for execution of the AI model 100.

In response to the request for execution of the AI model 100, the server device 1710 may execute the AI model 100. For example, the server device 1710 may perform pre-processing on the input prompt and the reference data, based on the task type information. The server device 1710 may add, to the input prompt, at least one token indicating the at least one task type indicated by the task type information. The server device 1710 may embed position information in at least one feature representing the reference data, by using one or more position offsets corresponding to the at least one task type indicated by the task type information. The server device 1710 may input the input prompt having added thereto the token and the reference data having embedded therein the position information to the AI model 100. The server device 1710 may transmit a response including an output of the AI model 100 to the electronic device 200. Based on the response from the server device 1710, the electronic device 200 may provide a response including the output of the AI model 100 to the user 10.

According to one or more embodiments of the disclosure, the electronic device 200 may generate an application programming interface (API) request including the information indicating the determined at least one task type, the input prompt, the reference data, and the request for execution of the AI model 100. The electronic device 200 may transmit the API request to the server device 1710. The API request may include information indicating an operation to be performed by the server device 1710, endpoint information indicating an API about execution of the AI model 100 of the server device 1710, information indicating validity of the API request, information indicating a type of contents of the API request, information about the electronic device 200, or a data part including actual data (e.g., the information indicating the determined at least one task type, the input prompt, and the reference data) to be transmitted to the server device 1710. However, a structure of the API request is not limited to the example.

The server device 1710 may receive the API request from the electronic device 200. The server device 1710 may verify the validity of the API request from the electronic device 200, based on the information indicating the validity of the API request which is included in the API request. Based on the API request not being valid, the server device 1710 may reject the API request and may inform the electronic device 200 of the rejection. Based on the API request being valid, the server device 1710 may identify a function requested by the electronic device 200, based on the endpoint information. The server device 1710 may extract data to be used in execution of the AI model 100, from the data part of the API request. For example, the server device 1710 may extract the information indicating the determined at least one task type, the input prompt, and the reference data from the data part of the API request. The server device 1710 may execute the AI model 100, based on the extracted data.

The server device 1710 may generate an API response including the output of the AI model 100. The server device 1710 may transmit the API response to the electronic device 200. The API response may include state information indicating a success or a failure in execution of the AI model 100, information indicating a type of contents of the API response, information indicating a time when the response is generated, information indicating a size of the response, and a data part including an actual output of the AI model 100. However, a structure of the API response is not limited to the example above.

The electronic device 200 may receive the API response from the server device 1710. Based on the state information included in the API response, the electronic device 200 may identify the success or the failure in execution of the AI model 100. Based on the failure in execution of the AI model 100 being identified, the electronic device 200 may provide the user 10 with a UI indicating an output generation failure. Based on the success in execution of the AI model 100 being identified, the electronic device 200 may extract an output of the AI model 100 from the data part of the API response. The electronic device 200 may generate a final response to be provided to the user 10, based on the extracted output of the AI model 100. For example, the electronic device 200 may generate a UI that displays visualization of the output of the AI model 100. The electronic device 200 may provide the user 10 with the generated UI via the user interface device 208. Accordingly, the output of the AI model 100 may be provided to the user 10.

According to one or more embodiments of the disclosure, the task type classifier 102 and the AI model 100 may be executed in the server device 1710. The electronic device 200 may obtain an input prompt and reference data from the user 10. The electronic device 200 may transmit, to the server device 1710, the input prompt and the reference data with a request for execution of the AI model 100. For example, the electronic device 200 may generate an API request including a data part indicating the input prompt and the reference data. The electronic device 200 may transmit the generated API request to the server device 1710.

The server device 1710 may receive the API request from the electronic device 200. The server device 1710 may execute the task type classifier 102 and the AI model 100, in response to the received API request. For example, the server device 1710 may determine at least one task type corresponding to the input prompt, by using the task type classifier 102. The server device 1710 may add, to the input prompt, at least one token indicating the determined at least one task type. The server device 1710 may embed position information in at least one feature representing the reference data, by using one or more position offsets corresponding to the determined at least one task type. The server device 1710 may input the input prompt having added thereto the token and the reference data having embedded therein the position information to the AI model 100. The server device 1710 may transmit an API response including an output of the AI model 100 to the electronic device 200. Based on the API response from the server device 1710, the electronic device 200 may provide a response including the output of the AI model 100 to the user 10.

According to one or more embodiments of the disclosure, the task type classifier 102 may be executed in the server device 1710, and the AI model 100 may be executed in the electronic device 200. The electronic device 200 may obtain an input prompt and reference data from the user 10. The electronic device 200 may transmit, to the server device 1710, the input prompt and the reference data with a request for execution of the task type classifier 102. For example, the electronic device 200 may generate an API request including a data part indicating the input prompt and the reference data and endpoint information indicating the task type classifier 102. The electronic device 200 may transmit the generated API request to the server device 1710.

The server device 1710 may receive the API request from the electronic device 200. In response to the received API request, the server device 1710 may execute the task type classifier 102. For example, the server device 1710 may determine at least one task type corresponding to the input prompt, by using the task type classifier 102. The server device 1710 may transmit, to the electronic device 200, an API response including a data part indicating the at least one task type determined by the task type classifier 102. The electronic device 200 may identify the at least one task type corresponding to the input prompt, based on the API response from the server device 1710. The electronic device 200 may add, to the input prompt, at least one token indicating the determined at least one task type. The electronic device 200 may embed position information in at least one feature representing the reference data, by using one or more position offsets corresponding to the determined at least one task type. The electronic device 200 may input the input prompt having added thereto the token and the reference data having embedded therein the position information to the AI model 100. The electronic device 200 may provide the user with a response including an output of the AI model 100.

According to one or more embodiments of the disclosure, the API request generated by the electronic device 200 may additionally include information for allowing the task type classifier 102 to be performed in the server device 1710. For example, the electronic device 200 may obtain, from the user 10, task information indicating a task type. The electronic device 200 may generate an API request additionally including the task information, and may transmit the generated API request to the server device 1710.

According to one or more embodiments of the disclosure, the API request generated by the electronic device 200 may additionally include information for executing the AI model 100 in the server device 1710. For example, the electronic device 200 may obtain, from the user 10, an input for selecting one or more object areas in reference data. The electronic device 200 may generate an API request additionally including information for indicating the one or more object areas selected by the user 10, and may transmit the generated API request to the server device 1710. For example, the electronic device 200 may obtain, from the user 10, information about a modality of reference data. The electronic device 200 may generate an API request additionally including the information about the modality of the reference data, and may transmit the generated API request to the server device 1710.

According to one or more embodiments of the disclosure, a method may include obtaining an input prompt and reference data from a user, determining at least one task type corresponding to the input prompt, adding, to the input prompt, a token indicating the determined at least one task type, based on the determined at least one task type, embedding position information in the reference data, inputting, to an AI model, the input prompt having added thereto the token and the reference data having embedded therein the position information, and providing the user with an output corresponding to the input prompt, based on an output of the AI model. According to the method, a plurality of tasks may be processed by using one AI model.

According to one or more embodiments of the disclosure, the determining of the at least one task type corresponding to the input prompt may include inputting the input prompt to a language model trained to classify a target task of a given prompt into at least one type, and determining the at least one task type, based on an output of the language model.

According to one or more embodiments of the disclosure, the determining of the at least one task type corresponding to the input prompt may include obtaining, from the user, task information indicating a target task of the input prompt, and determining at least one type of the target task, based on the task information.

According to one or more embodiments of the disclosure, the embedding of the position information in the reference data may include encoding the reference data so as to obtain at least one feature representing the reference data, generating at least one position embedding representing a position of the at least one feature, by using a position offset corresponding to the determined at least one task type, and combining the at least one position embedding with the at least one feature.

According to one or more embodiments of the disclosure, the determining of the at least one task type corresponding to the input prompt may include determining a first task type and a second task type which correspond to the input prompt. The adding of, to the input prompt, the token indicating the determined at least one task type may include adding, to the input prompt, a first token indicating the first task type and a second token indicating the second task type.

According to one or more embodiments of the disclosure, the determining of the at least one task type corresponding to the input prompt may include determining a first task type and a second task type which correspond to the input prompt. The embedding of the position information in the reference data may include encoding the reference data so as to obtain at least one feature representing the reference data, generating at least one position embedding indicating a position of the at least one feature, by using a first position offset corresponding to the first task type and a second position offset corresponding to the second task type, and combining the at least one position embedding with the at least one feature.

According to one or more embodiments of the disclosure, the method may further include obtaining, from the user, an additional input prompt for the output of the AI model, determining at least one additional task type corresponding to the additional input prompt, adding, to the additional input prompt, an additional token indicating the determined at least one additional task type, embedding position information in the output of the AI model, based on the determined at least one additional task type, inputting, to the AI model, the additional input prompt having added thereto the additional token and the output of the AI model having embedded therein the position information, obtaining an additional output from the AI model, and providing the user with an output corresponding to the additional input prompt, based on the additional output from the AI model.

According to one or more embodiments of the disclosure, the obtaining of the input prompt and the reference data from the user may include obtaining, from the user, one or more object areas in the reference data which are related to the target task of the input prompt. Accordingly, objects to be used in performing a task may be further clearly taught to the AI model.

According to one or more embodiments of the disclosure, the determining of the at least one task type corresponding to the input prompt may include identifying at least one of an object included in the reference data or an object included in the input prompt, and determining the at least one task type corresponding to the input prompt, based on the identified at least one object.

According to one or more embodiments of the disclosure, the embedding of the position information in the reference data may include identifying a modality of the reference data, and embedding the position information in the reference data, based on the identified modality of the reference data.

According to one or more embodiments of the disclosure, a computer-readable recoding medium may have stored therein a program for performing, on a computer, any methods, operations, or a combination of operations according to the disclosure.

According to one or more embodiments of the disclosure, an electronic device may include a processor including processing circuitry, and memory storing at least one instruction, wherein the at least one instruction, when executed by the processor individually or collectively, causes the electronic device to obtain an input prompt and reference data from a user, determine at least one task type corresponding to the input prompt, add, to the input prompt, a token indicating the determined at least one task type, based on the determined at least one task type, embed position information in the reference data, input, to an AI model, the input prompt having added thereto the token and the reference data having embedded therein the position information, and provide the user with an output corresponding to the input prompt, based on an output of the AI model.

According to one or more embodiments of the disclosure, the at least one instruction, when executed by the processor individually or collectively, may cause the electronic device to input the input prompt to a language model trained to classify a target task of a given prompt into at least one type, and determine the at least one task type, based on an output of the language model.

According to one or more embodiments of the disclosure, the at least one instruction, when executed by the processor individually or collectively, may cause the electronic device to obtain, from the user, task information indicating a target task of the input prompt, and determine at least one type of the target task, based on the task information.

According to one or more embodiments of the disclosure, the at least one instruction, when executed by the processor individually or collectively, may cause the electronic device to encode the reference data so as to obtain at least one feature representing the reference data, generate at least one position embedding representing a position of the at least one feature, by using a position offset corresponding to the determined at least one task type, and combine the at least one position embedding with the at least one feature.

According to one or more embodiments of the disclosure, the at least one instruction, when executed by the processor individually or collectively, may cause the electronic device to determine a first task type and a second task type which correspond to the input prompt. According to one or more embodiments of the disclosure, the at least one instruction, when executed by the processor individually or collectively, may cause the electronic device to add, to the input prompt, a first token indicating the first task type and a second token indicating the second task type.

According to one or more embodiments of the disclosure, the at least one instruction, when executed by the processor individually or collectively, may cause the electronic device to determine a first task type and a second task type which correspond to the input prompt. According to one or more embodiments of the disclosure, the at least one instruction, when executed by the processor individually or collectively, may cause the electronic device to encode the reference data so as to obtain at least one feature representing the reference data, generate at least one position embedding indicating a position of the at least one feature, by using a first position offset corresponding to the first task type and a second position offset corresponding to the second task type, and combine the at least one position embedding with the at least one feature.

According to one or more embodiments of the disclosure, the at least one instruction, when executed by the processor individually or collectively, may cause the electronic device to obtain, from the user, an additional input prompt for the output of the AI model, determine at least one additional task type corresponding to the additional input prompt, add, to the additional input prompt, an additional token indicating the determined at least one additional task type, embed position information in the output of the AI model, based on the determined at least one additional task type, input, to the AI model, the additional input prompt having added thereto the additional token and the output of the AI model having embedded therein the position information, obtain an additional output from the AI model, and provide the user with an output corresponding to the additional input prompt, based on the additional output from the AI model.

According to one or more embodiments of the disclosure, the at least one instruction, when executed by the processor individually or collectively, may cause the electronic device to obtain, from the user, one or more object areas in the reference data which are related to the target task of the input prompt. Accordingly, objects to be used in performing a task may be further clearly taught to the AI model.

According to one or more embodiments of the disclosure, the at least one instruction, when executed by the processor individually or collectively, may cause the electronic device to identify at least one of an object included in the reference data or an object included in the input prompt, and determine the at least one task type corresponding to the input prompt, based on the identified at least one object.

According to one or more embodiments of the disclosure, the at least one instruction, when executed by the processor individually or collectively, may cause the electronic device to identify a modality of the reference data, and embed the position information in the reference data, based on the identified modality of the reference data.

A machine-readable storage medium may be provided in the form of a non-transitory storage medium. Here, the term ‘non-transitory storage medium’ may mean that the storage medium is a tangible device and does not include signals (e.g., electromagnetic waves), and may mean that data may be permanently or temporarily stored in the storage medium. For example, the ‘non-transitory storage medium’ may include a buffer in which data is temporarily stored.

According to one or more embodiments of the disclosure, the method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online via an application store or directly between two user apparatuses (e.g., smartphones). In a case of online distribution, at least a portion of the computer program product (e.g., a downloadable application) may be at least temporarily stored or temporarily generated in a machine-readable storage medium such as a manufacturer's server, a server of an application store, or a memory of a relay server.

Although the embodiments of the disclosure have been described with the limited embodiments and the drawings, various modifications and changes may be made by one of skill in the art from the above description. For example, suitable results may be obtained even when the described techniques are performed in a different order, or when components in a described electronic device, architecture, device, or circuit are coupled or combined in a different manner, or replaced or supplemented by other components or their equivalents.

What is claimed is:

1. A method comprising:
obtaining an input prompt and reference data;
determining at least one task type corresponding to the input prompt;
adding a token to the input prompt, the token indicating the at least one task type;
embedding, based on the at least one task type, position information in the reference data;
inputting, to an artificial intelligence (AI) model, the input prompt comprising the token and the reference data comprising the position information; and
providing an output corresponding to the input prompt, based on an output of the AI model.

2. The method of claim 1, wherein the determining the at least one task type corresponding to the input prompt comprises:
inputting the input prompt to a language model trained to classify a target task of a given prompt to at least one type; and
determining the at least one task type, based on an output of the language model.

3. The method of claim 1, wherein the determining the at least one task type corresponding to the input prompt comprises:
obtaining task information indicating a target task of the input prompt; and
determining at least one type of the target task, based on the task information.

4. The method of claim 1, wherein the embedding the position information in the reference data comprises:
obtaining at least one feature representing the reference data by encoding the reference data;
generating at least one position embedding representing a position of the at least one feature, by using a position offset corresponding to the at least one task type; and
combining the at least one position embedding with the at least one feature.

5. The method of claim 1, wherein the determining the at least one task type corresponding to the input prompt comprises determining a first task type and a second task type which correspond to the input prompt, and
wherein the adding the token to the input prompt comprises adding a first token indicating the first task type and a second token indicating the second task type to the input prompt.

6. The method of claim 1, wherein the determining the at least one task type corresponding to the input prompt comprises determining a first task type and a second task type which correspond to the input prompt, and
wherein the embedding the position information in the reference data comprises:
obtaining at least one feature representing the reference data by encoding the reference data;
generating at least one position embedding indicating a position of the at least one feature, based on a first position offset corresponding to the first task type and a second position offset corresponding to the second task type; and
combining the at least one position embedding with the at least one feature.

7. The method of claim 1, further comprising:
obtaining an additional input prompt associated with the output of the AI model;
determining at least one additional task type corresponding to the additional input prompt;
adding, to the additional input prompt, an additional token indicating the determined at least one additional task type;
embedding additional position information in the output of the AI model, based on the determined at least one additional task type;
inputting, to the AI model, the additional input prompt comprising the additional token and the output of the AI model comprising the additional position information;
obtaining an additional output from the AI model; and
providing an output corresponding to the additional input prompt, based on the additional output from the AI model.

8. The method of claim 1, wherein the obtaining the input prompt and the reference data comprises obtaining one or more object areas in the reference data which are related to a target task of the input prompt.

9. The method of claim 1, wherein the determining the at least one task type corresponding to the input prompt comprises:
identifying at least one of an object comprised in the reference data or the input prompt; and
determining the at least one task type corresponding to the input prompt, based on the at least one object.

10. The method of claim 1, wherein the embedding the position information in the reference data comprises:
identifying a modality of the reference data; and
embedding the position information in the reference data, based on the modality of the reference data.

11. A non-transitory computer-readable recording medium having recorded thereon a program that is executed by at least one processor to perform the method of claim 1.

12. An electronic device comprising:
one or more processors comprising processing circuitry; and
memory storing at least one instruction,
wherein the at least one instruction, when executed by the one or more processors individually or collectively, causes the electronic device to:
obtain an input prompt and reference data,
determine at least one task type corresponding to the input prompt,
add a token to the input prompt, the token indicating the at least one task type,
embed, based on the at least one task type, position information in the reference data,
input, to an artificial intelligence (AI) model, the input prompt comprising the token and the reference data comprising the position information, and
provide an output corresponding to the input prompt, based on an output of the AI model.

13. The electronic device of claim 12, wherein the at least one instruction, when executed by the one or more processors individually or collectively, causes the electronic device to:
input the input prompt to a language model trained to classify a target task of a given prompt to at least one type, and
determine the at least one task type, based on an output of the language model.

14. The electronic device of claim 12, wherein the at least one instruction, when executed by the one or more processors individually or collectively, causes the electronic device to:
obtain task information indicating a target task of the input prompt, and
determine at least one type of the target task, based on the task information.

15. The electronic device of claim 12, wherein the at least one instruction, when executed by the one or more processors individually or collectively, causes the electronic device to:
obtain at least one feature representing the reference data by encoding the reference data,
generate at least one position embedding representing a position of the at least one feature, based on a position offset corresponding to the at least one task type, and
combine the at least one position embedding with the at least one feature.

16. The electronic device of claim 12, wherein the at least one instruction, when executed by the one or more processors individually or collectively, causes the electronic device to:
determine a first task type and a second task type which correspond to the input prompt, and
add a first token indicating the first task type and a second token indicating the second task type to the input prompt.

17. The electronic device of claim 12, wherein the at least one instruction, when executed by the one or more processors individually or collectively, causes the electronic device to:
determine a first task type and a second task type which correspond to the input prompt,
obtain at least one feature representing the reference data by encoding the reference data,
generate at least one position embedding indicating a position of the at least one feature, based on a first position offset corresponding to the first task type and a second position offset corresponding to the second task type, and
combine the at least one position embedding with the at least one feature.

18. The electronic device of claim 12, wherein the at least one instruction, when executed by the one or more processors individually or collectively, causes the electronic device to obtain one or more object areas in the reference data which are related to a target task of the input prompt.

19. The electronic device of claim 12, wherein the at least one instruction, when executed by the one or more processors individually or collectively, causes the electronic device to:
identify at least one of an object comprised in the reference data or the input prompt, and
determine the at least one task type corresponding to the input prompt, based on the at least one object.

20. The electronic device of claim 12, wherein the at least one instruction, when executed by the one or more processors individually or collectively, causes the electronic device to:
identify a modality of the reference data, and
embed the position information in the reference data, based on the modality of the reference data.
